(19) United States
(12) Patent Application Publication
(10) Pub. No.: US 2026/0196186 A1
(43) Pub. Date: Jul. 9, 2026

(54) ILLUSION PRESENTATION SYSTEM, ILLUSION IMAGE PRESENTATION DEVICE, ILLUSION IMAGE GENERATION DEVICE, ILLUSION IMAGE PRESENTATION METHOD, ILLUSION IMAGE GENERATION METHOD, AND PROGRAM

(71) Applicant: NTT, Inc., Tokyo (JP)

(72) Inventor: Takahiro KAWABE, Tokyo (JP)

(73) Assignee: NTT, Inc., Tokyo (JP)

(21) Appl. No.: 18/868,755

(22) PCT Filed: Jun. 2, 2022
(86) PCT No.: PCT/JP2022/022462

§ 371 Date: Nov. 24, 2024

(51) Int. Cl. G09G 5/10

(52) U.S. Cl. CPC G09G 5/10; G09G 2320/0233; G09G 2320/0613; G09G 2320/0686

(57) ABSTRACT

A plurality of final targets is visually recognized in a state of being arranged on a background or a video therefor is generated. A first final target includes a first target object and a first additional region added to at least a part of a contour line of the first target object. A second final target includes a second target object and a second additional region added to at least a part of a contour line of the second target object. The luminance of the background is uniform at each time, and periodically and temporally changes between a maximum luminance and a minimum luminance. Each of a luminance of the first target object, a luminance of the second target object, a luminance of the first additional region, and a luminance of the second additional region is a uniform luminance that is between the maximum luminance and the minimum luminance and does not temporally change. A luminance of the first target object and a luminance of the second target object are different. A luminance of the first additional region and a luminance of the second additional region are same, and lower than a luminance of the first target object and a luminance of the second target object or higher than a luminance of the first target object and a luminance of the second target object.

### TECHNICAL FIELD

The present invention relates to a technique for causing a feeling as if a real object or a target in an image that is not actually moving is moving.

### BACKGROUND ART

Non Patent Literature 1 discloses a technique of causing an illusion that a square is moving by adding a white region having a constant width to the outside of one side of two straight line sides parallel to each other in a gray square, adding a black region having a constant width to the outside of the other side, and arranging the square on a background that blinks in which the entire luminance is uniform. Patent Literature 1 discloses a technique of causing an illusion that a target object is moving by, regarding a target object having any shape, a dark object having substantially the same shape or a substantially similar shape as that of the target object and having a luminance lower than that of the target object, and a light object having substantially the same shape or a substantially similar shape as that of the target object and having a luminance higher than that of the target object, arranging an object equivalent to an object obtained by any one of incomplete superposition of covering a part of the dark object and a part of the light object with the target object, incomplete superposition of covering a part of the dark object with the target object, and incomplete superposition of covering a part of the light object with the target object on a background that blinks in which the entire luminance is uniform.

Furthermore, Patent Literature 1 discloses a technique of causing an illusion that timings of movement of portions of an object or a plurality of objects are different by driving a background of a black and white stripe pattern by a roller to blink the luminance of a background in a state where the luminance of the entire background at each time is not uniform and the luminance of each partial region of the background at each time is different.

### CITATION LIST

### Patent Literature

Patent Literature 1: WO2019/208194A1

### Non Patent Literature

Non Patent Literature 1: Gregory, R. L., & Heard, P. F. (1983). Visual dissociations of movement, position, and stereo depth: some phenomenal phenomena. The Quarterly Journal of Experimental Psychology. A, Human Experimental Psychology, 35(Pt 1), 217-237.

### SUMMARY OF INVENTION

### Technical Problem

Assuming that a gray square to which a white region having a constant width and a black region having a constant width are added in Non Patent Literature 1 is also referred to as an object, in a case where a plurality of objects is arranged on a background that blinks in which the entire luminance is uniform, an illusion that the plurality of objects is moving at the same timing can be caused using both the technique of Non Patent Literature 1 and the technique of Patent Literature 1, but an illusion that the plurality of objects is moving at different timings cannot be caused. Although Patent Literature 1 also describes a technique of causing an illusion that a plurality of objects is moving at different timings, there is an issue that control of making the luminance of each partial region of the background at each time different is required.

An object of the present invention is to provide a technique of causing an illusion that a plurality of objects is moving at different timings in a state where the plurality of objects is arranged on a background that blinks in which the entire luminance is uniform without requiring control of setting the luminance of each partial region of the background at each time to a different state.

### Solution to Problem

In a first aspect, an illusion presentation system for causing an illusion that visual objects based on N (N is an integer of 2 or more) final targets are visually moving is provided. In this illusion presentation system, N final target matters in which the respective final targets are visually recognized from a surface side or an arranged matter in which the N final targets are visually recognized from a surface side of a transparent or translucent material is arranged on a presentation surface. As a first final target among the N final targets, a first target object and a first additional region added to at least a part of a contour line of the first target object are visually recognized from a surface side. As a second final target among the N final targets, a second target object and a second additional region added to at least a part of a contour line of the second target object are visually recognized from a surface side. A luminance of the presentation surface is uniform at each time, and periodically and temporally changes between a predetermined maximum luminance and a predetermined minimum luminance. Each of a luminance of the first target object, a luminance of the second target object, a luminance of the first additional region, and a luminance of the second additional region is a uniform predetermined luminance that is between the maximum luminance and the minimum luminance and does not temporally change. A luminance of the first target object and a luminance of the second target object are different. A luminance of the first additional region and a luminance of the second additional region are same, and lower than a luminance of the first target object and a luminance of the second target object or higher than a luminance of the first target object and a luminance of the second target object.

In a second aspect, an illusion video presentation device that presents a video for causing an illusion that visual objects based on N (N is an integer of 2 or more) final targets are visually moving is provided. A video presented by the illusion video presentation device includes the N final targets and a background region. A first final target among the N final targets includes a first target object and a first additional region added to at least a part of a contour line of the first target object. A second final target among the N final targets includes a second target object and a second additional region added to at least a part of a contour line of the second target object. A luminance of the background region is uniform at each time, and periodically and temporally changes between a predetermined maximum luminance and a predetermined minimum luminance. Each of a luminance of the first target object, a luminance of the second target object, a luminance of the first additional region, and a luminance of the second additional region is a uniform predetermined luminance that is between the maximum luminance and the minimum luminance and does not temporally change. A luminance of the first target object and a luminance of the second target object are different. A luminance of the first additional region and a luminance of the second additional region are same, and lower than a luminance of the first target object and a luminance of the second target object or higher than a luminance of the first target object and a luminance of the second target object.

In a third aspect, an illusion video generation device that generates a video for causing an illusion that visual objects based on N (N is an integer of 2 or more) final targets are visually moving is provided. The illusion video generation device generates a video including the N final targets and a background region. A first final target among the N final targets includes a first target object and a first additional region added to at least a part of a contour line of the first target object. A second final target among the N final targets includes a second target object and a second additional region added to at least a part of a contour line of the second target object. A luminance of the background region is uniform at each time, and periodically and temporally changes between a predetermined maximum luminance and a predetermined minimum luminance. Each of a luminance of the first target object, a luminance of the second target object, a luminance of the first additional region, and a luminance of the second additional region is a uniform predetermined luminance that is between the maximum luminance and the minimum luminance and does not temporally change. A luminance of the first target object and a luminance of the second target object are different. A luminance of the first additional dark region and a luminance of the second additional dark region are same, and lower than a luminance of the first target object and a luminance of the second target object or higher than a luminance of the first target object and a luminance of the second target object.

### Advantageous Effects of Invention

According to the present invention, an illusion that a plurality of objects is moving at different timings can be caused in a state where the plurality of objects is arranged on a background that blinks in which the entire luminance is uniform without control of setting the luminance of each partial region of the background at each time to a different state required.

### BRIEF DESCRIPTION OF DRAWINGS

FIG. 1 is a block diagram illustrating a functional configuration of an illusion presentation system 400 according to a first embodiment to a third embodiment and a modification of the third embodiment.

FIG. 2 is a flowchart illustrating processing of an illusion video generation device 100 according to the first embodiment to the third embodiment and the modification of the third embodiment.

FIG. 3 is a diagram illustrating an example of a target object image 11.

FIG. 4A is a diagram illustrating an example of a first target object 10-1 and a region 10R-1 corresponding to the first target object 10-1 that has been moved parallelly in the right direction. FIG. 4B is a diagram illustrating an example of the first target object 10-1, a first additional dark region 20-1, and a first final target 40-1 of the first embodiment.

FIG. 5A is a diagram illustrating an example of a second target object 10-2 and a region 10R-2 corresponding to the second target object 10-2 that has been rotationally moved clockwise. FIG. 5B is a diagram illustrating an example of the second target object 10-2, a second additional dark region 20-2, and a second final target 40-2 of the first embodiment.

FIG. 6A is a diagram illustrating an example of the first target object 10-1 and a region 10B-1 corresponding to the enlarged first target object 10-1. FIG. 6B is a diagram illustrating an example of the first target object 10-1, the first additional dark region 20-1, and a first final target 40-1 of the first embodiment.

FIG. 7A is a diagram illustrating an example of the second target object 10-2 and a region 10R-2 having a constant width outside the right side of the second target object 10-2. FIG. 7B is a diagram illustrating an example of the second target object 10-2, the second additional dark region 20-2, and the second final target 40-2 of the first embodiment.

FIG. 8 is a diagram illustrating an example of a final target image 21 of the first embodiment.

FIG. 9 is a diagram illustrating an example of a presentation video 60 of the first embodiment.

FIG. 10A is a diagram illustrating an example of a relationship between frame numbers and luminances of background regions of presentation images of the respective frame numbers. FIG. 10B is a diagram illustrating another example of the relationship between frame numbers and luminances of background regions of presentation images of the respective frame numbers. FIG. 10C is a diagram illustrating still another example of the relationship between the frame numbers and luminances of background regions of presentation images of the respective frame numbers.

FIG. 11 is a diagram illustrating an example of a final target image 21 of a second embodiment.

FIG. 12 is a diagram illustrating an example of a presentation video 60 of the second embodiment.

FIG. 13A is a diagram illustrating an example of a first target object 10-1, a region 10R-1 corresponding to the first target object 10-1 that has been moved parallelly in the right direction, and a region 10L-1 corresponding to the first target object 10-1 that has been moved parallelly in the left direction. FIG. 13B is a diagram illustrating an example of a first target object 10-1, a first additional dark region 20-1, a first additional light region 30-1, and a first final target 40-1 of the third embodiment.

FIG. 14A is a diagram illustrating an example of a second target object 10-2, a region 10R-2 corresponding to the second target object 10-2 that has been rotationally moved clockwise, and a region 10L-2 corresponding to the second target object 10-2 that has been rotationally moved counterclockwise. FIG. 14B is a diagram illustrating an example of the second target object 10-2, a second additional dark region 20-2, a second additional light region 30-2, and a second final target 40-2 of the third embodiment.

FIG. 15A is a diagram illustrating an example of the second target object 10-2, the region 10R-2 having a constant width outside the right side of the second target object 10-2, and the region 10L-2 having a constant width outside the left side of the second target object 10-2. FIG. 15B is a diagram illustrating an example of the second target object 10-2, the second additional dark region 20-2, the second additional light region 30-2, and the second final target 40-2 of the third embodiment.

FIG. 16 is a diagram illustrating an example of a final target image 21 of the third embodiment.

FIG. 17 is a diagram illustrating an example of a presentation video 60 of the third embodiment.

FIG. 18 is a block diagram illustrating a functional configuration of an illusion presentation system 404 according to a fourth embodiment.

FIG. 19 is a flowchart illustrating processing of the illusion presentation system 404 according to the fourth embodiment.

FIG. 20A is a diagram illustrating an example of a background presentation device 304 according to the fourth embodiment. FIG. 20B is a diagram illustrating another example of the background presentation device 304 according to the fourth embodiment.

FIG. 21A is a diagram illustrating an example of an illusion presentation method by the illusion presentation system 404 according to the fourth embodiment. FIG. 21B is a diagram illustrating another example of the illusion presentation method by the illusion presentation system 404 according to the fourth embodiment.

FIG. 22 is a diagram illustrating an example of a functional configuration of a computer that implements an illusion video generation device or an illusion video presentation device according to each embodiment and a modification.

### DESCRIPTION OF EMBODIMENTS

### First Embodiment

In a first embodiment, an illusion presentation system will be described that generates a video in which a plurality of target objects each to which a region having a luminance lower than that of the target object is added is arranged on a background that blinks in which the entire luminance is uniform, and presents the generated video so as to cause an illusion that a plurality of objects is moving at different timings.

### Illusion Presentation System 400

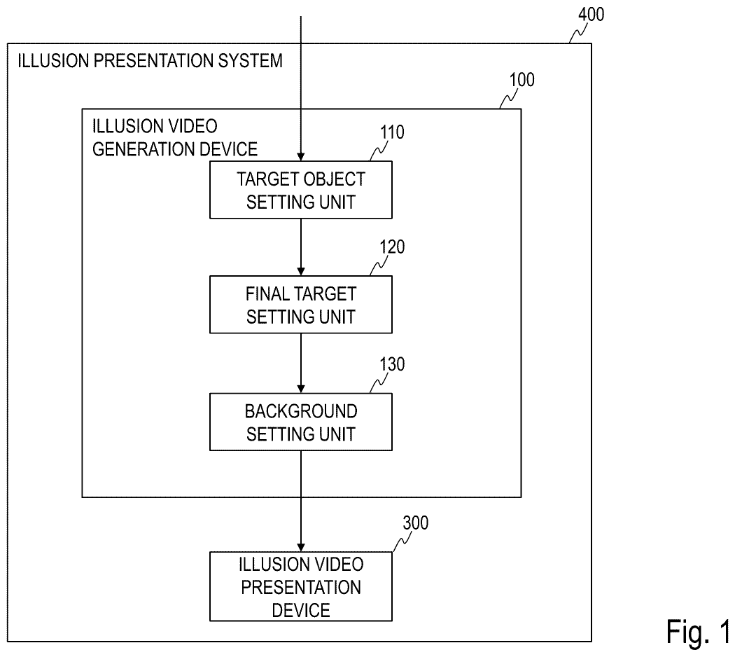

As illustrated in FIG. 1, an illusion presentation system 400 according to the first embodiment includes an illusion video generation device 100 that generates a video presented by an illusion video presentation device 300 and the illusion video presentation device 300 that presents a video generated by the illusion video generation device 100.

### Illusion Video Generation Device 100

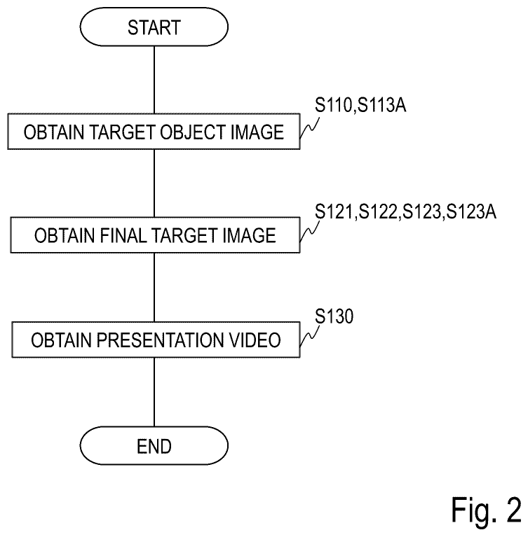

As illustrated in FIG. 1, the illusion video generation device 100 according to the first embodiment includes a target object setting unit 110, a final target setting unit 120, and a background setting unit 130. The illusion video generation device 100 performs processing of step S110, step S121, and step S130 illustrated in FIG. 2. Note that, in consideration of easy understanding of the description, an example in which an image and a video are rectangles on a two-dimensional xy plane, and the resolution on the xy plane is the same will be described below. That is, in all images and videos, the number of pixels in the x direction is the same, and the number of pixels in the y direction is the same. The pixel value of each pixel is a value that increases as the luminance increases.

### Target Object Setting Unit 110

The target object setting unit 110 obtains a target object image that is an image including a plurality of target objects that satisfies luminance conditions to be described below (step S110). The target object setting unit 110 outputs the target object image to the final target setting unit 120. In a case where an input image including target objects is input to the illusion video generation device 100, the target object setting unit 110 is required to cut out a plurality of regions of the target objects from the input image and arrange the regions in a target object image. The target object setting unit 110 may arrange a plurality of target objects obtained by cutting out one or more regions of target objects from each of a plurality of input images in a target object image, or may arrange a plurality of target objects obtained by cutting out regions of a plurality of target objects from one input image in a target object image. In a case where a drawing operation from the user is input to the illusion video generation device 100, the target object setting unit 110 is required to arrange a plurality of target objects in a target object image according to the input drawing operation. The shape of each of the target objects may be any shape.

The luminance conditions of a target object are as follows. The luminance of each target object is uniform. That is, in each target object, pixel values of all pixels included in the target object are substantially the same. A plurality of target objects includes at least target objects having mutually different luminances. That is, the luminances of all target objects may be different, but the luminances of all the target objects cannot be the same. The luminances of all target objects are luminances between a predetermined maximum luminance and a predetermined minimum luminance lower than the maximum luminance, and are higher than the luminance of an additional dark region to be described below. As will be described below, since the luminance of an additional dark region is higher than the predetermined minimum luminance, the luminances of all target objects are luminances between the luminance of the additional dark region and the predetermined maximum luminance after all, and more specifically, the luminances of all target objects are higher than the luminance of the additional dark region and lower than the predetermined maximum luminance. The predetermined maximum luminance is a maximum value of a luminance in a periodic temporal change of the luminance of a background region to be described below. The predetermined minimum luminance is a minimum value of a luminance in a periodic temporal change of the luminance of the background region to be described below.

The luminance of each target object may be automatically set by the target object setting unit 110 such that the above-described conditions are satisfied, or the user may select a desired luminance from among luminances that satisfy the above-described conditions. In a case where the user can select a desired luminance from among luminances that satisfy the above-described conditions, a selection operation from the user is required to be input to the illusion video generation device 100, and the target object setting unit 110 is required to set a luminance corresponding to the input selection operation for each target object.

Since a region other than target objects in a target object image is a region that serves as an additional dark region or a background region to be described below, and the luminance is set by the final target setting unit 120 and the background setting unit 130 to be described below, the luminance of the region other than target objects in a target object image does not affect a video finally output by the illusion video generation device 100. Therefore, the luminance of the region other than target objects in a target object image is any luminance. That is, the target object setting unit 110 is required to set any luminance different from the luminance of any target object for the region other than target objects in a target object image.

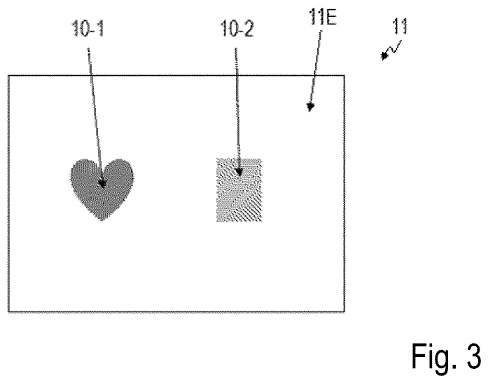

An example of a target object image 11 including two target objects is illustrated in FIG. 3. The target object image 11 includes a first target object 10-1, a second target object 10-2, and a region 11E other than target objects. The luminance of the first target object 10-1 is uniform. The luminance of the second target object 10-2 is also uniform. The luminance of the first target object 10-1 and the luminance of the second target object 10-2 are different. Specifically, the luminance of the first target object 10-1 is lower than the luminance of the second target object 10-2.

### Final Target Setting Unit 120

A target object image output by the target object setting unit 110 is input to the final target setting unit 120. For each of the target objects included in the target object image, the final target setting unit 120 generates, as a final target, the target object to which an additional dark region that is a region in contact with at least a part of a contour line of the target object and satisfies luminance conditions to be described below is added, and obtains a final target image that is an image including a plurality of generated final targets (step S121). The final target setting unit 120 outputs the final target image to the background setting unit 130.

The luminance conditions of an additional dark region are as follows. The luminance of each additional dark region is uniform. The luminances of all additional dark regions are the same. The luminances of all additional dark regions are lower than the luminances of all target objects and higher than a predetermined minimum luminance (that is, minimum value of a luminance in a periodic temporal change of the luminance of a background region to be described below). That is, the pixel values of all pixels included in all additional dark regions are substantially the same value lower than the luminances of all target objects and higher than the predetermined minimum luminance.

The luminance of an additional dark region may be automatically set by the final target setting unit 120 such that the above-described conditions are satisfied, or the user may select a desired luminance from among luminances that satisfy the above-described conditions. In a case where the user can select a desired luminance from among luminances that satisfy the above-described conditions, a selection operation from the user is required to be input to the illusion video generation device 100, and the final target setting unit 120 is required to set a luminance corresponding to the input selection operation as the luminances of all additional dark regions.

For example, for each of the target objects, the final target setting unit 120 is required to set a portion not overlapping the target object in a region corresponding to the target object that has been moved and/or enlarged as an additional region, set the additional region for which a luminance that satisfies the above-described luminance conditions of an additional dark region is set as an additional dark region, and obtain the target object to which the additional dark region is added as a final target. The movement may be parallel movement, rotational movement, or other movement. Hereinafter, a plurality of examples of a method in which the final target setting unit 120 obtains a final target will be described, but the final target may be obtained by a method other than these examples.

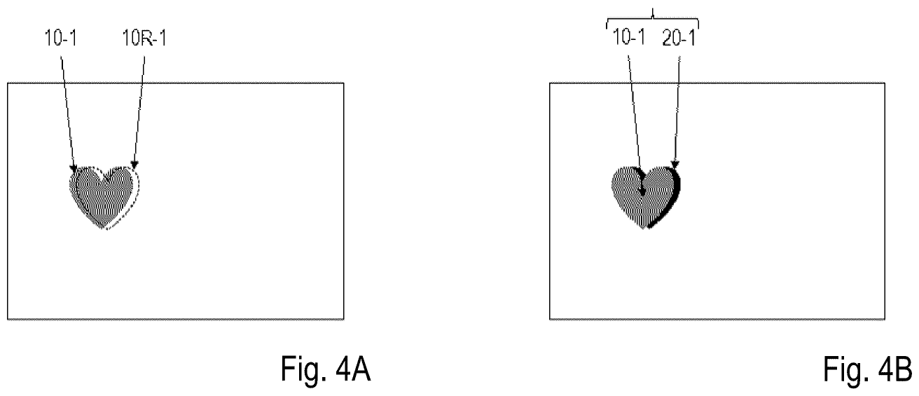

For example, for a certain target object, the final target setting unit 120 sets a portion not overlapping the target object in a region corresponding to the target object that has been parallelly moved in a certain direction as an additional region, sets the additional region for which a luminance that satisfies the above-described luminance conditions of an additional dark region is set as an additional dark region, and obtains the target object to which the additional dark region is added as a final target. Referring to FIGS. 4A and 4B by taking the first target object 10-1 as an example, a region corresponding to the first target object 10-1 that has been parallelly moved in the right direction is a region 10R-1 indicated by a broken line in FIG. 4A, a portion not overlapping the first target object 10-1 in the region 10R-1 for which a luminance that satisfies the above-described luminance conditions of an additional dark region is set is a first additional dark region 20-1 indicated in black in FIG. 4B, and the first target object 10-1 to which the first additional dark region 20-1 is added is a first final target 40-1.

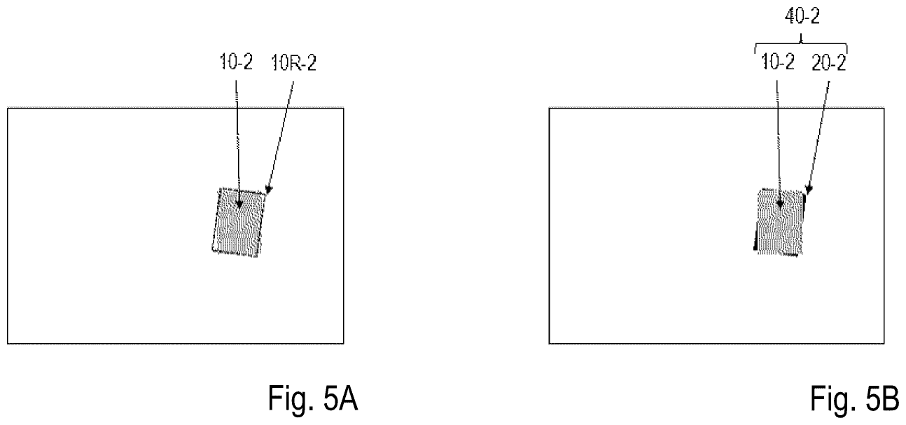

For example, for a certain target object, the final target setting unit 120 sets a portion not overlapping the target object in a region corresponding to the target object that has been rotationally moved in a certain direction using a certain point of the target object as a center as an additional region, sets the additional region for which a luminance that satisfies the above-described luminance conditions of an additional dark region is set as an additional dark region, and obtains the target object to which the additional dark region is added as a final target. Referring to FIGS. 5A and 5B by taking the second target object 10-2 as an example, a region corresponding to the second target object 10-2 that has been rotationally moved clockwise using the centroid of the second target object 10-2 as a center is a region 10R-2 indicated by a broken line in FIG. 5A, a portion not overlapping the second target object 10-2 in the region 10R-2 for which a luminance that satisfies the above-described luminance conditions of an additional dark region is set is a second additional dark region 20-2 indicated in black in FIG. 5B, and the second target object 10-2 to which the second additional dark region 20-2 is added is a second final target 40-2.

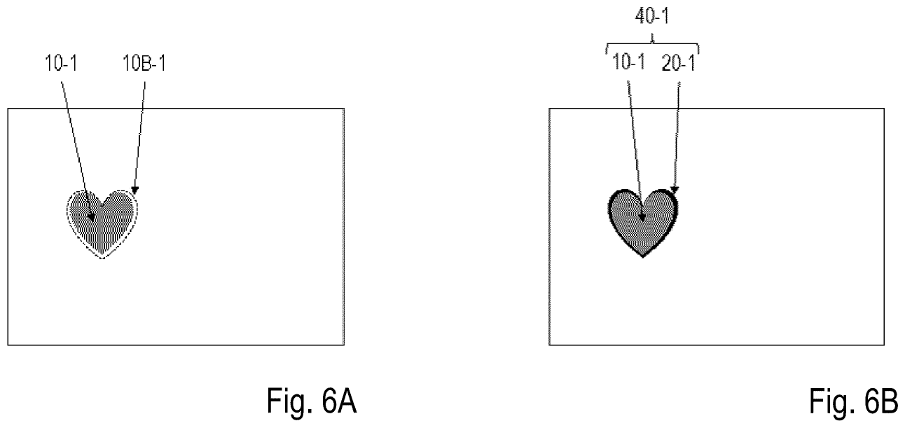

For example, for a certain target object, the final target setting unit 120 sets a portion not overlapping the target object in a region corresponding to the target object that has been enlarged using a certain point of the target object as a center as an additional region, sets the additional region for which a luminance that satisfies the above-described luminance conditions of an additional dark region is set as an additional dark region, and obtains the target object to which the additional dark region is added as a final target. Referring to FIGS. 6A and 6B by taking the first target object 10-1 as an example, a region corresponding to the first target object 10-1 that has been enlarged using the centroid of the first target object 10-1 as a center is a region 10B-1 indicated by a broken line in FIG. 6A, a portion not overlapping the first target object 10-1 in the region 10B-1for which a luminance that satisfies the above-described luminance conditions of an additional dark region is set is a first additional dark region 20-1 indicated in black in FIG. 6B, and the first target object 10-1 to which the first additional dark region 20-1 is added is a first final target 40-1.

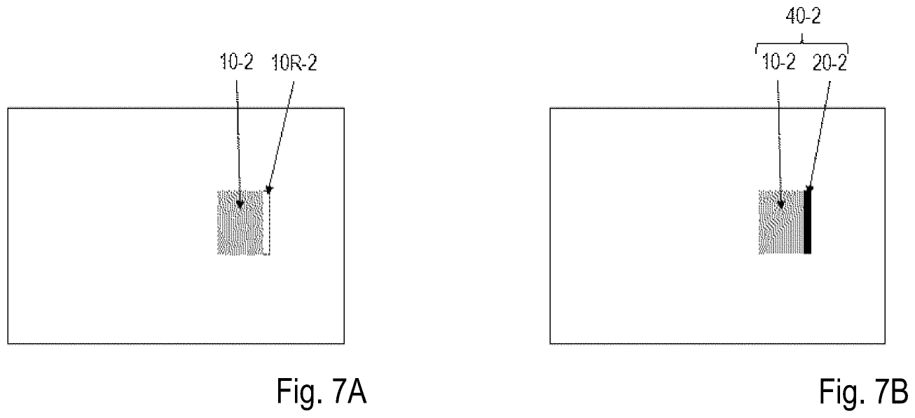

For example, for a certain rectangular target object, the final target setting unit 120 sets a region having a constant width outside at least one side of the target object as an additional region, sets the additional region for which a luminance that satisfies the above-described luminance conditions of an additional dark region is set as an additional dark region, and obtains the target object to which the additional dark region is added as a final target. Referring to FIGS. 7A and 7B by taking the second target object 10-2 as an example, a region having a constant width outside the right side of the second target object 10-2 is a region 10R-2 indicated by a broken line in FIG. 7A, the region 10R-2 for which a luminance that satisfies the above-described luminance conditions of an additional dark region is set is a second additional dark region 20-2 indicated in black in FIG. 7B, and the second target object 10-2to which the second additional dark region 20-2 is added is a second final target 40-2.

The maximum width of an additional dark region is desirably a width at or near a viewing angle of 0.2 degrees. For example, in a case where a final target is viewed from a position about 100 centimeters away, the maximum width of the additional dark region is desirably about 3.5 millimeters. Therefore, the final target setting unit 120 is required to obtain the additional region using, for example, a movement amount and/or a rotation amount and/or an enlargement amount and/or a width of the additional region that make the maximum width of the additional dark region the desirable values. The maximum width of the additional dark region may be larger or smaller than the width at which the viewing angle is 0.2 degrees, although the effect of a caused illusion is less as compared to a case where the maximum width of the additional dark region is at a viewing angle of 0.2 degrees.

Since a region other than final targets in a final target image is a region that serves as a background region to be described below, and the luminance is set by the background setting unit 130 to be described below, the luminance of the region other than final targets in a final target image does not affect a video finally output by the illusion video generation device 100. Therefore, the luminance of the region other than final targets in a final target image is any luminance. That is, the final target setting unit 120 may set any luminance different from the luminance of any target object and the luminances of additional dark regions for the region other than final targets in a final target image.

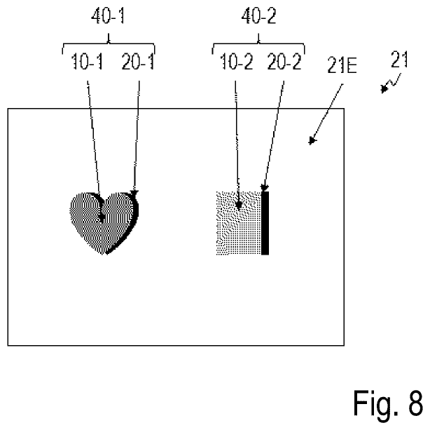

An example of a final target image 21 including two final targets is illustrated in FIG. 8. The final target image 21 includes a first final target 40-1, a second final target 40-2, and a region 21E other than final targets. The first final target 40-1 includes a first target object 10-1 and a first additional dark region 20-1 added to at least a part of a contour line of the first target object 10-1. The second final target 40-2 includes a second target object 10-2 and a second additional dark region 20-2 added to at least a part of a contour line of the second target object 10-2. The luminance of the first target object 10-1 is uniform. The luminance of the second target object 10-2 is also uniform. The luminance of the first target object 10-1 and the luminance of the second target object 10-2 are different. Specifically, the luminance of the first target object 10-1 is lower than the luminance of the second target object 10-2. The luminance of the first additional dark region 20-1 is uniform. The luminance of the second additional dark region 20-2 is also uniform. The luminance of the first additional dark region 20-1 and the luminance of the second additional dark region 20-2 are the same. The luminance of the first additional dark region 20-1 and the luminance of the second additional dark region 20-2 are lower than the luminance of the first target object 10-1. That is, the luminance of the first additional dark region 20-1 and the luminance of the second additional dark region 20-2 are lower than the luminance of the first target object 10-1 and the luminance of the second target object 10-2.

### Background Setting Unit 130

A final target image output by the final target setting unit 120 is input to the background setting unit 130. The background setting unit 130 sets a region other than final targets of the final target image (that is, region not included in any final target) as a background region, and generates a video in which the luminance of the background region is periodically and temporally changed as a presentation video (step S130). The background setting unit 130 outputs the generated presentation video to the illusion video generation device 100 as an output of the illusion video presentation device 300. At each time, the luminance of the background region is uniform. That is, at each time, the pixel values of all pixels included in the background region are substantially the same. The maximum value of the luminance of the background region that periodically and temporally changes is the predetermined maximum luminance described above. The minimum value of the luminance of the background region that periodically and temporally changes is the predetermined minimum luminance described above. The shape of the waveform of the periodic temporal change of the luminance of the background region may be, for example, a triangular waveform, a sine waveform, or a sawtooth waveform, and in short, may be any shape.

For example, the background setting unit 130 generates a plurality of frames of presentation images, and connects the generated presentation images in order of frame numbers to obtain a presentation video 60. In a presentation image of each of the frames included in the presentation video, the luminance of the background region 50 is uniform. In the plurality of frames of the presentation images included in the presentation video 60, as the time elapses, that is, as the frame number increases, an increase in luminance toward the maximum luminance and a decrease in luminance toward the minimum luminance are sequentially repeated.

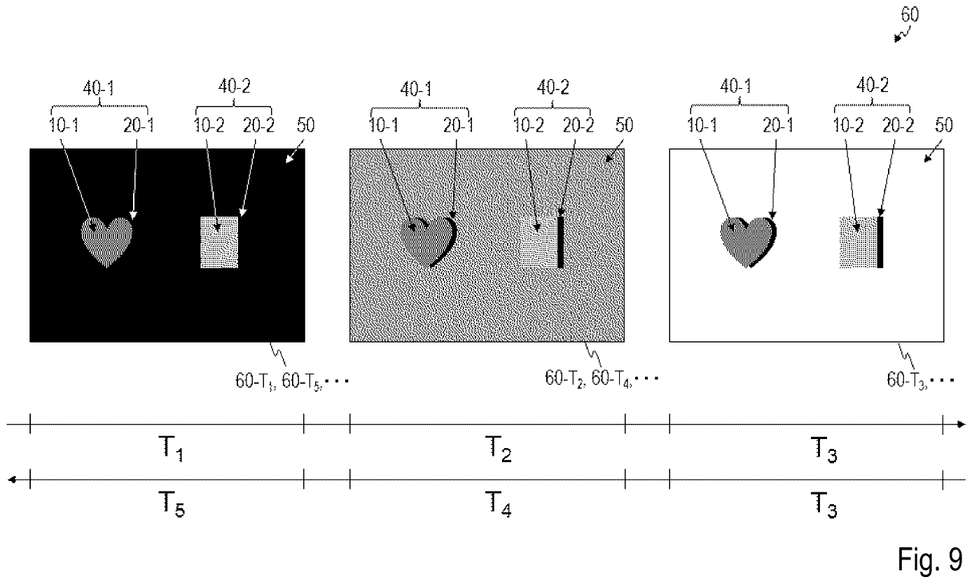

FIG. 9 illustrates an example of the presentation video 60. For example, as illustrated in FIG. 9, when the order of times is T₁, T₂, T₃, T₄, T₅, . . . , the luminance of the background region 50 of a presentation image 60−T₁ at a time T₁ in the presentation video 60 is the minimum luminance, the luminance of the background region 50 of a presentation image 60−T₂ at a time T₂ in the presentation video 60 is a luminance higher than the minimum luminance and lower than the maximum luminance, the luminance of the background region 50 of a presentation image 60−T₃ at a time T₃ in the presentation video 60 is the maximum luminance, the luminance of the background region 50 of a presentation image 60−T₄ at a time T₄ in the presentation video 60 is a luminance higher than the minimum luminance and lower than the maximum luminance, and the luminance of the background region 50 of a presentation image 60−T₅ at a time T₅ in the presentation video 60 is the minimum luminance.

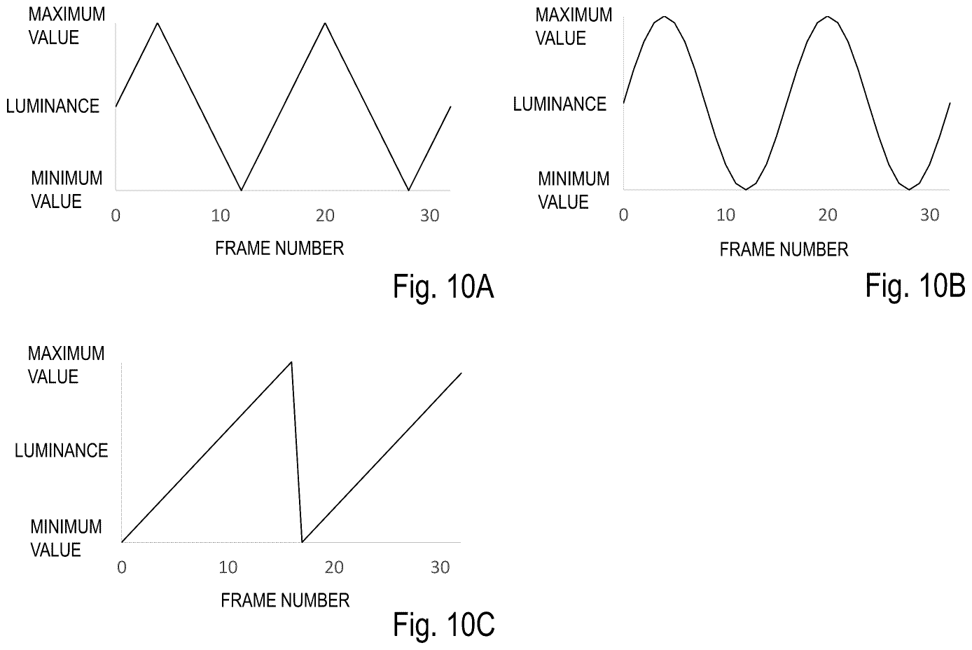

FIGS. 10A to 10C are diagrams illustrating examples of a relationship between the frame numbers and luminances of background regions of presentation images of the respective frame numbers. FIG. 10A illustrates an example in which the luminance of the background region is periodically and temporally changed in a triangular waveform, FIG. 10B illustrates an example in which the luminance of the background region is periodically and temporally changed in a sine waveform, and FIG. 10C illustrates an example in which the luminance of the background region is periodically and temporally changed in a sawtooth waveform.

### Illusion Video Presentation Device 300

A presentation video output from the illusion video generation device 100 is input to the illusion video presentation device 300. The illusion video presentation device 300 presents the presentation video (step S300). The illusion video presentation device 300 may include, for example, a display screen such as a liquid crystal display device or an organic EL display device and present an input presentation video on the display screen, may include a projector and a screen, and present an input presentation video on the screen by the projector, or may be any device as long as the device presents a presentation video such that an observer can visually recognize the video. When an integer of 2 or more is N, the presentation video generated by the illusion video generation device 100 according to the first embodiment and presented by the illusion video presentation device 300 is a video for causing an illusion that visual objects based on N final targets are visually moving, and includes the N final targets and a background region. A first final target among the N final targets includes a first target object and a first additional dark region added to at least a part of a contour line of the first target object. A second final target among the N final targets includes a second target object and a second additional dark region added to at least a part of a contour line of the second target object. A luminance of the background region is uniform at each time, and periodically and temporally changes between a predetermined maximum luminance and a predetermined minimum luminance. Each of the luminance of the first target object, the luminance of the second target object, the luminance of the first additional dark region, and the luminance of the second additional dark region is a uniform predetermined luminance that is between the maximum luminance and the minimum luminance and does not temporally change. A luminance of the first target object and a luminance of the second target object are different. The luminance of the first additional dark region and the luminance of the second additional dark region are the same and lower than the luminance of the first target object and the luminance of the second target object. By the above-described presentation video being presented by the illusion video presentation device 300, an observer who has viewed the presentation video has an illusion that visual objects based on respective final targets are visually moving at different timings.

### Second Embodiment

In a second embodiment, an illusion presentation system will be described that generates a video in which a plurality of target objects each to which a region having a luminance higher than that of the target object is added is arranged on a background that blinks in which the entire luminance is uniform, and presents the generated video so as to cause an illusion that a plurality of objects is moving at different timings.

Hereinafter, an illusion presentation system according to the second embodiment will be described focusing on differences from the illusion presentation system 400 according to the first embodiment while omitting description of the same points as the illusion presentation system 400 according to the first embodiment as appropriate.

### Illusion Presentation System 400

As illustrated in FIG. 1, an illusion presentation system 400 according to the second embodiment includes an illusion video generation device 100 that generates a video presented by an illusion video presentation device 300 and the illusion video presentation device 300 that presents a video generated by the illusion video generation device 100, similarly to the illusion presentation system 400 according to the first embodiment.

### Illusion Video Generation Device 100

As illustrated in FIG. 1, the illusion video generation device 100 according to the second embodiment includes a target object setting unit 110, a final target setting unit 120, and a background setting unit 130, similarly to the illusion video generation device 100 according to the first embodiment. The illusion video generation device 100 performs processing of step S110, step S122, and step S130 illustrated in FIG. 2.

### Target Object Setting Unit 110

The target object setting unit 110 obtains a target object image that is an image including a plurality of target objects that satisfies luminance conditions to be described below (step S110). The target object setting unit 110 outputs the target object image to the final target setting unit 120. Processing of arranging target objects performed by the target object setting unit 110 is similar to that of the first embodiment. The shape of each of the target objects is also similar to that of the first embodiment. That is, the shape of each of the target objects may be any shape.

The luminance conditions of a target object are as follows. The luminance of each target object is uniform. That is, in each target object, pixel values of all pixels included in the target object are substantially the same. A plurality of target objects includes at least target objects having mutually different luminances. That is, the luminances of all target objects may be different, but the luminances of all the target objects cannot be the same. The luminances of all target objects are luminances between a predetermined maximum luminance and a predetermined minimum luminance, and are lower than the luminance of an additional light region to be described below. As will be described below, since the luminance of an additional light region is lower than the predetermined maximum luminance, the luminances of all target objects are luminances between the luminance of the additional light region and the predetermined minimum luminance after all, and more specifically, the luminances of all target objects are lower than the luminance of the additional light region and higher than the predetermined minimum luminance.

For the same reason as described in the first embodiment, the luminance of the region other than target objects in a target object image is any luminance. As can be seen from the above description, the operation of the target object setting unit 110 is the same as that of the first embodiment except that the luminances of all target objects are lower than the luminance of an additional light region, and a target object image obtained by the target object setting unit 110 is the same as that of the first embodiment except that the luminances of all target objects are lower than the luminance of an additional light region. Furthermore, since the relationship between the luminances of target objects and the luminance of an additional light region, which is a portion different from that of the first embodiment, does not appear in a target object image itself, an example of a target object image including two target objects is FIG. 3, similarly to the first embodiment.

### Final Target Setting Unit 120

A target object image output by the target object setting unit 110 is input to the final target setting unit 120. For each target object included in the target object image, the final target setting unit 120 generates, as a final target, the target object to which an additional light region that is a region in contact with at least a part of a contour line of the target object and satisfies luminance conditions to be described below is added, and obtains a final target image that is an image including a plurality of generated final targets (step S122). The final target setting unit 120 outputs the final target image to the background setting unit 130.

The luminance conditions of an additional light region are as follows. The luminance of each additional light region is uniform. The luminances of all additional light regions are the same. The luminances of all additional light regions are higher than the luminances of all target objects and lower than a predetermined maximum luminance (that is, maximum value of a luminance in a periodic temporal change of the luminance of a background region to be described below). That is, the pixel values of all pixels included in all additional light regions are substantially the same value higher than the luminances of all target objects and lower than the predetermined maximum luminance.

The luminance of an additional light region may be automatically set by the final target setting unit 120 such that the above-described conditions are satisfied, or the user may select a desired luminance from among luminances that satisfy the above-described conditions. In a case where the user can select a desired luminance from among luminances that satisfy the above-described conditions, a selection operation from the user is required to be input to the illusion video generation device 100, and the final target setting unit 120 is required to set a luminance corresponding to the input selection operation as the luminances of all additional light regions.

For example, for each target object, the final target setting unit 120 is required to set a portion not overlapping the target object in a region corresponding to the target object that has been moved and/or enlarged as an additional region, set the additional region for which a luminance that satisfies the above-described luminance conditions of an additional light region is set as an additional light region, and obtain the target object to which the additional light region is added as a final target. The movement may be parallel movement, rotational movement, or other movement. Processing in which, for each target object, the final target setting unit 120 sets a portion not overlapping the target object in a region corresponding to the target object that has been moved and/or enlarged as an additional region is similar to the processing of the first embodiment, and the processing is required to be performed by a method similar to that exemplified in the first embodiment or the like.

The maximum width of an additional light region is the same as the maximum width of an additional dark region of the first embodiment. That is, the maximum width of an additional light region is desirably a width at or near a viewing angle of 0.2 degrees. For example, in a case where a final target is viewed from a position about 100 centimeters away, that the maximum width of the additional light region is desirably about 3.5 millimeters. Therefore, the final target setting unit 120 is required to obtain the additional region using, for example, a movement amount and/or a rotation amount and/or an enlargement amount and/or a width of the additional region that make the maximum width of the additional light region the desirable values. The maximum width of the additional light region may be larger or smaller than the width at which the viewing angle is 0.2 degrees, although the effect of a caused illusion is less as compared to a case where the maximum width of the additional light region is at a viewing angle of 0.2 degrees.

For the same reason as described in the first embodiment, the luminance of the region other than a final target in a final target image is any luminance. As can be seen from the above description, the operation of the final target setting unit 120 is the same as that of the first embodiment except that an additional light region having a luminance higher than those of all target objects is included in a final target image instead of an additional dark region having a luminance lower than those of all target objects. Furthermore, the final target image obtained by the final target setting unit 120 is the same as that of the first embodiment except that the final target image includes an additional light region having a luminance higher than those of all target objects instead of an additional dark region having a luminance lower than those of all target objects.

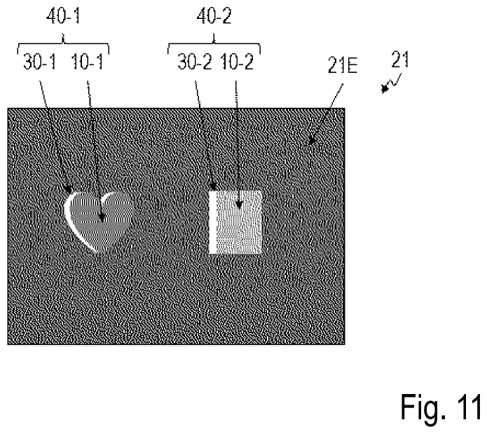

An example of a final target image 21 including two final targets is illustrated in FIG. 11. The final target image 21 includes a first final target 40-1, a second final target 40-2, and a region 21E other than final targets. The first final target 40-1 includes a first target object 10-1 and a first additional light region 30-1 added to at least a part of a contour line of the first target object 10-1. The second final target 40-2 includes a second target object 10-2 and a second additional light region 30-2 added to at least a part of a contour line of the second target object 10-2. The luminance of the first target object 10-1 is uniform. The luminance of the second target object 10-2 is also uniform. The luminance of the first target object 10-1 and the luminance of the second target object 10-2 are different. Specifically, the luminance of the first target object 10-1 is lower than the luminance of the second target object 10-2. The luminance of the first additional light region 30-1 is uniform. The luminance of the second additional light region 30-2 is also uniform. The luminance of the first additional light region 30-1 and the luminance of the second additional light region 30-2 are the same. The luminance of the first additional light region 30-1 and the luminance of the second additional light region 30-2 are higher than the luminance of the second target object 10-2. That is, the luminance of the first additional light region 30-1 and the luminance of the second additional light region 30-2 are higher than the luminance of the first target object 10-1 and the luminance of the second target object 10-2.

### Background Setting Unit 130

A final target image output by the final target setting unit 120 is input to the background setting unit 130. The background setting unit 130 sets a region other than final targets of the final target image (that is, region not included in any final target) as a background region, and generates a video in which the luminance of the background region is periodically and temporally changed as a presentation video (step S130). The background setting unit 130 outputs the generated presentation video to the illusion video generation device 100 as an output of the illusion video presentation device 300. Although the final target image input to the background setting unit 130 is different from that of the first embodiment, processing of generating a presentation video performed by the background setting unit 130 is similar to that of the first embodiment. The luminance of the background region is also similar to that of the first embodiment, and the luminance of the background region is uniform at each time, the maximum value of the luminance of the background region that periodically and temporally changes is the predetermined maximum luminance described above, and the minimum value of the luminance of the background region that periodically and temporally changes is the predetermined minimum luminance described above. The shape of the waveform of the periodic temporal change of the luminance of the background region is similar to that of the first embodiment, and the shape of the waveform of the periodic temporal change of the luminance of the background region may be any shape.

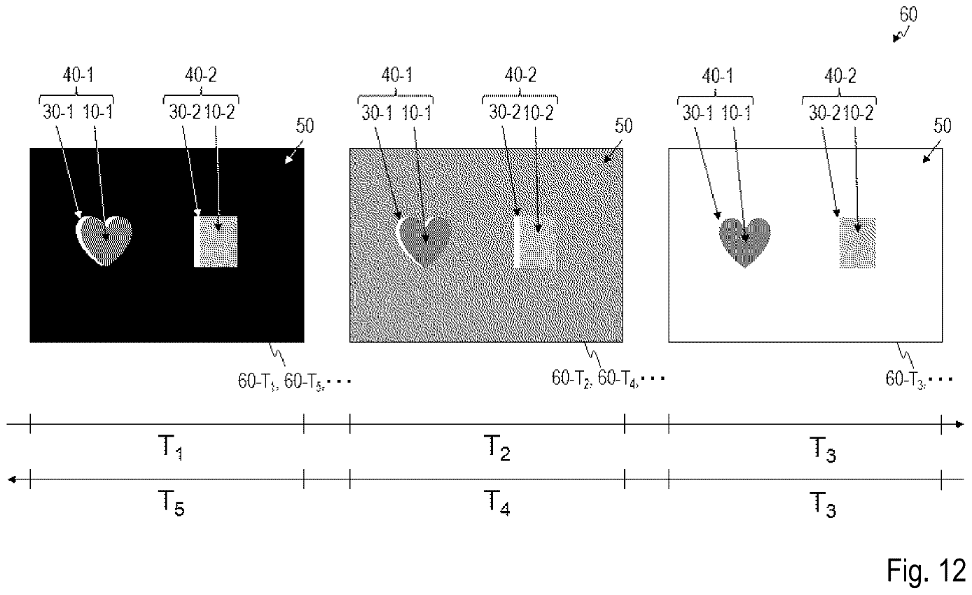

FIG. 12 illustrates an example of a presentation video 60. As illustrated in FIG. 12, when the order of times is T₁, T₂, T₃, T₄, T₅, . . . , the luminance of the background region 50 of a presentation image 60−T₁ at a time T₁ in the presentation video 60 is the minimum luminance, the luminance of the background region 50 of a presentation image 60−T₂ at a time T₂ in the presentation video 60 is a luminance higher than the minimum luminance and lower than the maximum luminance, the luminance of the background region 50 of a presentation image 60−T₃ at a time T₃ in the presentation video 60 is the maximum luminance, the luminance of the background region 50 of a presentation image 60−T₄ at a time T₄ in the presentation video 60 is a luminance higher than the minimum luminance and lower than the maximum luminance, and the luminance of the background region 50 of a presentation image 60−T₅ at a time T₅ in the presentation video 60 is the minimum luminance.

### Illusion Video Presentation Device 300

A presentation video output from the illusion video generation device 100 is input to the illusion video presentation device 300. The illusion video presentation device 300 presents the presentation video (step S300). The example of the illusion video presentation device 300 is similar to that described in the first embodiment, and the illusion video presentation device 300 may be any device as long as the device presents a presentation video such that an observer can visually recognize the video. When an integer of 2 or more is N, the presentation video generated by the illusion video generation device 100 according to the second embodiment and presented by the illusion video presentation device 300 is a video for causing an illusion that visual objects based on N final targets are visually moving, and includes the N final targets and a background region. A first final target among the N final targets includes a first target object and a first additional light region added to at least a part of a contour line of the first target object. A second final target among the N final targets includes a second target object and a second additional light region added to at least a part of a contour line of the second target object. A luminance of the background region is uniform at each time, and periodically and temporally changes between a predetermined maximum luminance and a predetermined minimum luminance. Each of the luminance of the first target object, the luminance of the second target object, the luminance of the first additional light region, and the luminance of the second additional light region is a uniform predetermined luminance that is between the maximum luminance and the minimum luminance and does not temporally change. A luminance of the first target object and a luminance of the second target object are different. The luminance of the first additional light region and the luminance of the second additional light region are the same and higher than the luminance of the first target object and the luminance of the second target object. By the above-described presentation video being presented by the illusion video presentation device 300, an observer who has viewed the presentation video has an illusion that visual objects based on respective final targets are visually moving at different timings.

### Third Embodiment

In a third embodiment, an illusion presentation system will be described that generates a video in which a plurality of target objects each to which a region having a luminance lower and a region having a luminance higher than that of the target object are added is arranged on a background that blinks in which the entire luminance is uniform, and presents the generated video so as to cause an illusion that a plurality of objects is moving at different timings.

Hereinafter, an illusion presentation system according to the third embodiment will be described focusing on differences from the illusion presentation system 400 according to the first embodiment and the illusion presentation system 400 according to the second embodiment while omitting description of the same points as the illusion presentation system 400 according to the first embodiment and the illusion presentation system 400 according to the second embodiment as appropriate.

### Illusion Presentation System 400

As illustrated in FIG. 1, an illusion presentation system 400 according to the third embodiment includes an illusion video generation device 100 that generates a video presented by an illusion video presentation device 300 and the illusion video presentation device 300 that presents a video generated by the illusion video generation device 100, similarly to the illusion presentation system 400 according to the first embodiment and the illusion presentation system 400 according to the second embodiment.

### Illusion Video Generation Device 100

As illustrated in FIG. 1, the illusion video generation device 100 according to the third embodiment includes a target object setting unit 110, a final target setting unit 120, and a background setting unit 130, similarly to the illusion video generation device 100 according to the first embodiment and the illusion video generation device 100 according to the second embodiment. The illusion video generation device 100 performs processing of step S110, step S123, and step S130 illustrated in FIG. 2.

### Target Object Setting Unit 110

The target object setting unit 110 obtains a target object image that is an image including a plurality of target objects that satisfies luminance conditions to be described below (step S110). The target object setting unit 110 outputs the target object image to the final target setting unit 120. Processing of arranging target objects performed by the target object setting unit 110 is similar to that of the first embodiment and the second embodiment. The shape of each of the target objects is also similar to those of the first embodiment and the second embodiment. That is, the shape of each of the target objects may be any shape.

The luminance conditions of a target object are as follows. The luminance of each target object is uniform. That is, in each target object, pixel values of all pixels included in the target object are substantially the same. A plurality of target objects includes at least target objects having mutually different luminances. That is, the luminances of all target objects may be different, but the luminances of all the target objects cannot be the same. The luminances of all target objects are luminances between the luminance of an additional dark region and the luminance of an additional light region, and more specifically, are higher than the luminance of the additional dark region to be described below and lower than the luminance of the additional light region to be described below.

For the same reason as described in the first embodiment, the luminance of the region other than target objects in a target object image is any luminance. As can be seen from the above description, the operation of the target object setting unit 110 is the same as those of the first embodiment and the second embodiment except that the luminances of all target objects are higher than the luminance of an additional dark region and lower than the luminance of an additional light region, and a target object image obtained by the target object setting unit 110 is the same as those of the first embodiment and the second embodiment except that the luminances of all target objects are higher than the luminance of an additional dark region and lower than the luminance of an additional light region. Furthermore, since the relationship among the luminances of target objects, the luminance of an additional dark region, and the luminance of an additional light region, which is a portion different from those of the first embodiment and the second embodiment, does not appear in a target object image itself, an example of a target object image including two target objects is FIG. 3, similarly to the first embodiment and the second embodiment.

### Final Target Setting Unit 120

A target object image output by the target object setting unit 110 is input to the final target setting unit 120. For each target object included in the target object image, the final target setting unit 120 generates, as a final target, the target object to which an additional dark region that is a region in contact with at least a part of a contour line of the target object and satisfies luminance conditions to be described below and an additional light region that is a region in contact with at least a part of a contour line of the target object and satisfies luminance conditions to be described below are added, and obtains a final target image that is an image including a plurality of generated final targets (step S123). The final target setting unit 120 outputs the final target image to the background setting unit 130.

The luminance conditions of an additional dark region are the same as those in the first embodiment, and are as follows. The luminance of each additional dark region is uniform. The luminances of all additional dark regions are the same. The luminances of all additional dark regions are lower than the luminances of all target objects and higher than a predetermined minimum luminance (that is, minimum value of a luminance in a periodic temporal change of the luminance of a background region to be described below). That is, the pixel values of all pixels included in all additional dark regions are substantially the same value lower than the luminances of all target objects and higher than the predetermined minimum luminance.

The luminance conditions of an additional light region are the same as those in the second embodiment, and are as follows. The luminance of each additional light region is uniform. The luminances of all additional light regions are the same. The luminances of all additional light regions are higher than the luminances of all target objects and lower than a predetermined maximum luminance (that is, maximum value of a luminance in a periodic temporal change of the luminance of a background region to be described below). That is, the pixel values of all pixels included in all additional light regions are substantially the same value higher than the luminances of all target objects and lower than the predetermined maximum luminance.

Each of the luminance of an additional dark region and the luminance of an additional light region may be automatically set by the final target setting unit 120 such that the above-described conditions are satisfied, or the user may select a desired luminance from among luminances that satisfy the above-described conditions. In a case where the user can select a desired luminance from among luminances that satisfy the above-described conditions, a selection operation from the user for each of the luminance of an additional dark region and the luminance of an additional light region are required to be input to the illusion video generation device 100, and the final target setting unit 120 is required to set a luminance corresponding to the input selection operation for each of the luminance of an additional dark region and the luminance of an additional light region as the luminance of the additional dark region and the luminance of the additional light region.

For example, for each target object, the final target setting unit 120 is required to set a portion not overlapping the target object in a region corresponding to the target object that has been moved in a certain direction as a first additional region, set the first additional region for which a luminance that satisfies the above-described luminance conditions of an additional dark region is set as an additional dark region, set a portion not overlapping the target object in a region corresponding to the target object that has been moved in a direction different from the above-described certain direction as a second additional region, set the second additional region for which a luminance that satisfies the above-described luminance conditions of an additional light region is set as an additional light region, and obtain the target object to which the additional dark region and the additional light region are added as a final target. The movement may be parallel movement, rotational movement, or other movement. £ Hereinafter, a plurality of examples of a method in which the final target setting unit 120 obtains a final target will be described, but the final target may be obtained by a method other than these examples.

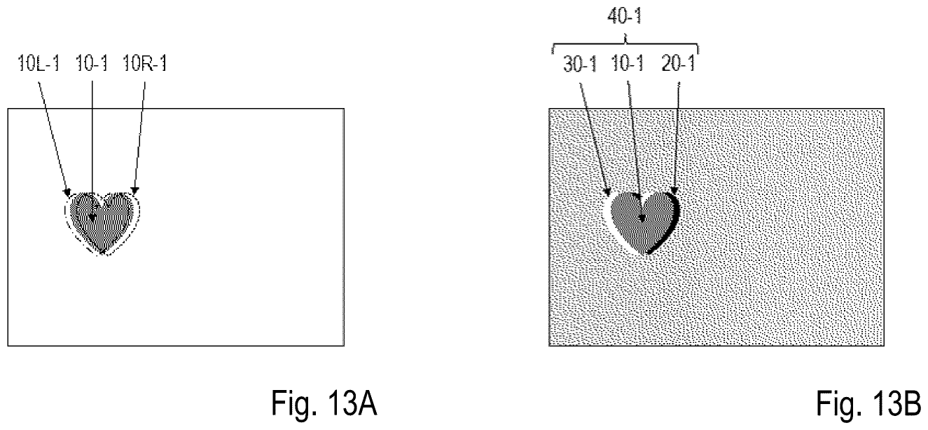

For example, for a certain target object, the final target setting unit 120 sets a portion not overlapping the target object in a region corresponding to the target object that has been parallelly moved in a certain direction as a first additional region, sets the first additional region for which a luminance that satisfies the above-described luminance conditions of an additional dark region is set as an additional dark region, sets a portion not overlapping the target object in a region corresponding to the target object that has been parallelly moved in a direction opposite to the above-described certain direction as a second additional region, sets the second additional region for which a luminance that satisfies the above-described luminance conditions of an additional light region is set as an additional light region, and obtains a target object to which the additional dark region and the additional light region are added as a final target. Referring to FIGS. 13A and 13B by taking a first target object 10-1 as an example, a region corresponding to the first target object 10-1 that has been parallelly moved in the right direction is a region 10R-1 indicated by a broken line in FIG. 13A, a portion not overlapping the first target object 10-1 in the region 10R-1 for which a luminance that satisfies the above-described luminance conditions of an additional dark region is set is a first additional dark region 20-1 indicated in black in FIG. 13B, a region corresponding to the first target object 10-1 that has been parallelly moved in the left direction is a region 10L-1 indicated by a one-dot chain line in FIG. 13A, a portion not overlapping the first target object 10-1 in the region 10L-1 for which a luminance that satisfies the above-described luminance conditions of an additional light region is set is a first additional light region 30-1 indicated in white in FIG. 13B, and the first target object 10-1 to which the first additional dark region 20-1 and the first additional light region 30-1 are added is a first final target 40-1.

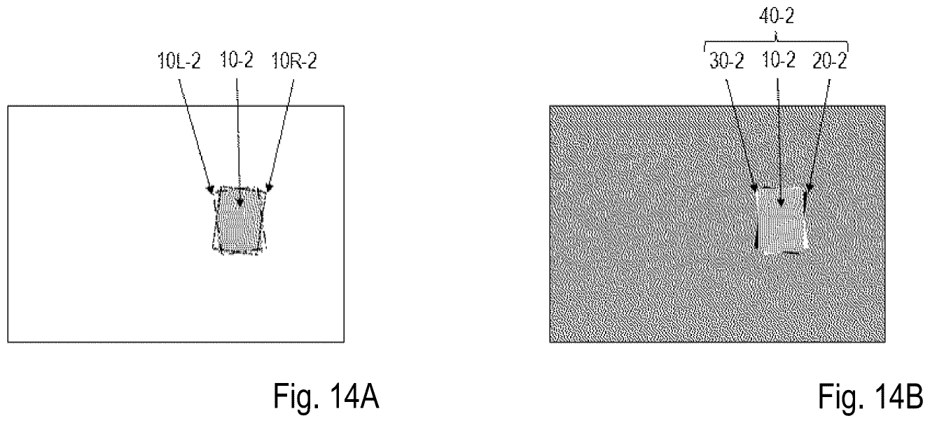

For example, for a certain target object, the final target setting unit 120 sets a portion not overlapping the target object in a region corresponding to the target object that has been rotationally moved in a certain rotational direction using a certain point of the target object as a center as a first additional region, sets the first additional region for which a luminance that satisfies the above-described luminance conditions of an additional dark region is set is an additional dark region, sets a portion not overlapping the target object in a region corresponding to the target object that has been rotationally moved in a rotational direction opposite to the above-described certain rotational direction using the certain point of the target object as a center as a second additional region, sets the second additional region for which a luminance that satisfies the above-described luminance conditions of an additional light region is set is an additional light region, and obtains the target object to which the additional dark region and the additional light region are added as a final target. Referring to FIGS. 14A and 14B by taking a second target object 10-2 as an example, a region corresponding to the second target object 10-2 that has been rotationally moved clockwise using the centroid of the second target object 10-2 as a center is a region 10R-2 indicated by a broken line in FIG. 14A, a portion not overlapping the second target object 10-2 in the region 10R-2 for which a luminance that satisfies the above-described luminance conditions of an additional dark region is set is a second additional dark region 20-2 indicated in black in FIG. 14B, a region corresponding to the second target object 10-2 that has been rotationally moved using the centroid of the second target object 10-2 as a center is a region 10L-2 indicated by a one-dot chain line in FIG. 14A, a portion not overlapping the second target object 10-2 in the region 10L-2 for which a luminance that satisfies the above-described luminance conditions of an additional light region is set is a second additional light region 30-2 indicated in white in FIG. 14B, and the second target object 10-2 to which the second additional dark region 20-2 and the second additional light region 30-2 are added is a second final target 40-2.

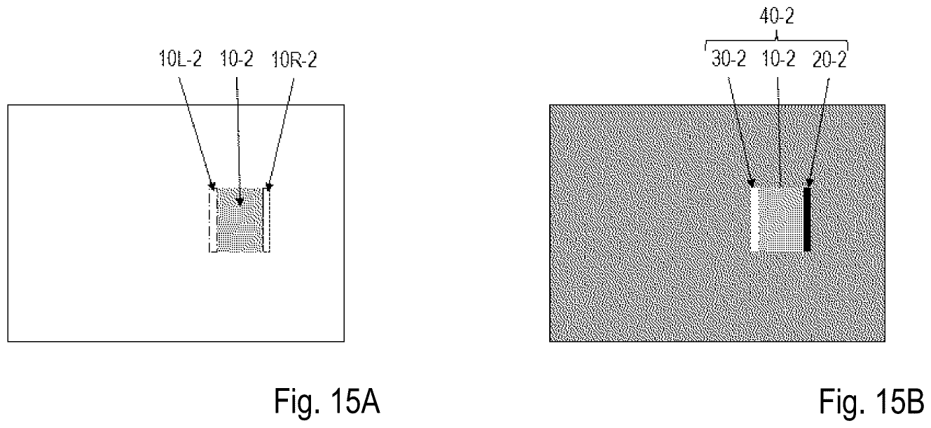

For example, for a certain rectangular target object, the final target setting unit 120 sets a portion having a constant width outside a certain side of the target object as a first additional region, sets the first additional region for which a luminance that satisfies the above-described luminance conditions of an additional dark region is set as an additional dark region, sets a portion having a constant width outside a side facing the above-described side of the target object as a second additional region, sets the second additional region for which a luminance that satisfies the above-described luminance conditions of an additional light region is set as an additional light region, and obtains the target object to which the additional dark region and the additional light region are added as a final target. Referring to FIGS. 15A and 15B by taking the second target object 10-2 as an example, a region having a constant width outside the right side of the second target object 10-2 is a region 10R-2 indicated by a broken line in FIG. 15A, the region 10R-2 for which a luminance that satisfies the above-described luminance conditions of an additional dark region is set is a second additional dark region 20-2 indicated in black in FIG. 15B, a region having a constant width outside the left side of the second target object 10-2 is a region 10L-2 indicated by a one-dot chain line in FIG. 15A, the region 10L-2 for which a luminance that satisfies the above-described luminance conditions of an additional light region is set is a second additional light region 30-2 indicated in white in FIG. 15B, and the second target object 10-2 to which the second additional dark region 20-2 and the second additional light region 30-2 are added is a second final target 40-2.

The maximum width of an additional dark region is similar to that of the first embodiment, and the maximum width of an additional light region is similar to that of the second embodiment. That is, both the maximum width of an additional dark region and the maximum width of an additional light region are desirably a width at or near a viewing angle of 0.2 degrees. For example, in a case where a final target is viewed from a position about 100 centimeters away, both the maximum width of the additional dark region and the maximum width of the additional light region are desirably about 3.5 millimeters. Therefore, the final target setting unit 120 is required to obtain the additional region using, for example, a movement amount and/or a rotation amount and/or an enlargement amount and/or a width of the additional region that make the maximum width of the additional dark region and the maximum width of the additional light region the desirable values. Both the maximum width of the additional dark region and the maximum width of the additional light region may be larger or smaller than the width at which the viewing angle is 0.2 degrees, although the effect of a caused illusion is less as compared to a case of a viewing angle of 0.2 degrees for both the maximum width of the additional dark region and the maximum width of the additional light region.

For the same reason as described in the first embodiment, the luminance of the region other than a final target in a final target image is any luminance.

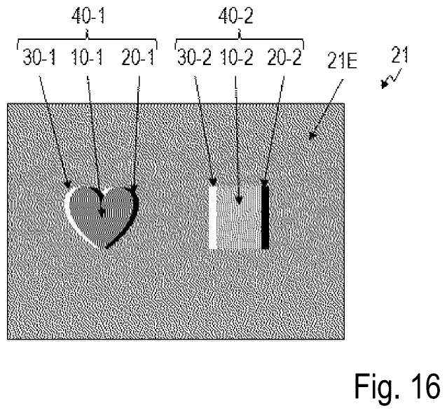

An example of a final target image 21 including two final targets is illustrated in FIG. 16. The final target image 21 includes a first final target 40-1, a second final target 40-2, and a region 21E other than final targets. The first final target 40-1 includes a first target object 10-1, a first additional dark region 20-1 added to at least a part of a contour line of the first target object 10-1, and a first additional light region 30-1 added to at least a part of a contour line of the first target object 10-1. The second final target 40-2 includes a second target object 10-2, a second additional dark region 20-2 added to at least a part of a contour line of the second target object 10-2, and a second additional light region 30-2 added to at least a part of a contour line of the second target object 10-2. The luminance of the first target object 10-1 is uniform. The luminance of the second target object 10-2 is also uniform. The luminance of the first target object 10-1 and the luminance of the second target object 10-2 are different. Specifically, the luminance of the first target object 10-1 is lower than the luminance of the second target object 10-2. The luminance of the first additional dark region 20-1 is uniform. The luminance of the second additional dark region 20-2 is also uniform. The luminance of the first additional dark region 20-1 and the luminance of the second additional dark region 20-2 are the same. The luminance of the first additional dark region 20-1 and the luminance of the second additional dark region 20-2 are lower than the luminance of the first target object 10-1. That is, the luminance of the first additional dark region 20-1 and the luminance of the second additional dark region 20-2 are lower than the luminance of the first target object 10-1 and the luminance of the second target object 10-2. The luminance of the first additional light region 30-1 is uniform. The luminance of the second additional light region 30-2 is also uniform. The luminance of the first additional light region 30-1 and the luminance of the second additional light region 30-2 are the same. The luminance of the first additional light region 30-1 and the luminance of the second additional light region 30-2 are higher than the luminance of the second target object 10-2. That is, the luminance of the first additional light region 30-1 and the luminance of the second additional light region 30-2 are higher than the luminance of the first target object 10-1 and the luminance of the second target object 10-2.

### Background Setting Unit 130

A final target image output by the final target setting unit 120 is input to the background setting unit 130. The background setting unit 130 sets a region other than final targets of the final target image (that is, region not included in any final target) as a background region, and generates a video in which the luminance of the background region is periodically and temporally changed as a presentation video (step S130). Although the final target image input to the background setting unit 130 is different from those of the first embodiment and the second embodiment, processing of generating a presentation video performed by the background setting unit 130 is similar to that of the first embodiment and the second embodiment. The luminance of the background region is also similar to those of the first embodiment and the second embodiment, and the luminance of the background region is uniform at each time, the maximum value of the luminance of the background region that periodically and temporally changes is the predetermined maximum luminance described above, and the minimum value of the luminance of the background region that periodically and temporally changes is the predetermined minimum luminance described above. The shape of the waveform of the periodic temporal change of the luminance of the background region is similar to those of the first embodiment and the second embodiment, and the shape of the waveform of the periodic temporal change of the luminance of the background region may be any shape.

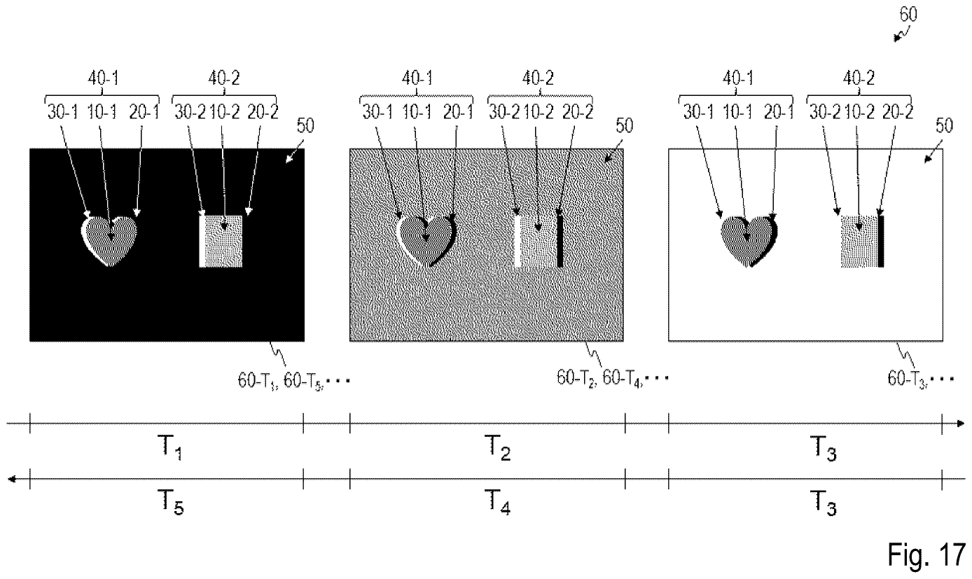

FIG. 17 illustrates an example of a presentation video 60. As illustrated in FIG. 17, when the order of times is T₁, T₂, T₃, T₄, T₅, . . . , the luminance of the background region 50 of a presentation image 60−T₁ at a time T₁ in the presentation video 60 is the minimum luminance, the luminance of the background region 50 of a presentation image 60−T₂ at a time T₂ in the presentation video 60 is a luminance higher than the minimum luminance and lower than the maximum luminance, the luminance of the background region 50 of a presentation image 60−T₃ at a time T₃ in the presentation video 60 is the maximum luminance, the luminance of the background region 50 of a presentation image 60−T₄ at a time T₄ in the presentation video 60 is a luminance higher than the minimum luminance and lower than the maximum luminance, and the luminance of the background region 50 of a presentation image 60−T₅ at a time T₅ in the presentation video 60 is the minimum luminance.

### Illusion Video Presentation Device 300

A presentation video output from the illusion video generation device 100 is input to the illusion video presentation device 300. The illusion video presentation device 300 presents the presentation video (step S300). The example of the illusion video presentation device 300 is similar to that described in the first embodiment, and the illusion video presentation device 300 may be any device as long as the device presents a presentation video such that an observer can visually recognize the video. When an integer of 2 or more is N, the presentation video generated by the illusion video generation device 100 according to the third embodiment and presented by the illusion video presentation device 300 is a video for causing an illusion that visual objects based on N final targets are visually moving, and includes the N final targets and a background region. A first final target among the N final targets includes a first target object, a first additional dark region added to at least a part of a contour line of the first target object, and a first additional light region added to at least a part of a contour line of the first target object. A second final target among the N final targets includes a second target object, a second additional dark region added to at least a part of a contour line of the second target object, and a second additional light region added to at least a part of a contour line of the second target object. A luminance of the background region is uniform at each time, and periodically and temporally changes between a predetermined maximum luminance and a predetermined minimum luminance. Each of the luminance of the first target object, the luminance of the second target object, the luminance of the first additional dark region, the luminance of the second additional dark region, the luminance of the first additional light region, and the luminance of the second additional light region is a uniform predetermined luminance that is between the maximum luminance and the minimum luminance and does not temporally change. A luminance of the first target object and a luminance of the second target object are different. The luminance of the first additional dark region and the luminance of the second additional dark region are the same and lower than the luminance of the first target object and the luminance of the second target object. The luminance of the first additional light region and the luminance of the second additional light region are the same and higher than the luminance of the first target object and the luminance of the second target object. By the above-described presentation video being presented by the illusion video presentation device 300, an observer who has viewed the presentation video has an illusion that visual objects based on respective final targets are visually moving at different timings.

### Modification of Third Embodiment

Although a form in which both an additional dark region and an additional light region are included in all final targets included in a presentation video has been described in the third embodiment, in a case where three or more final targets are included in a presentation video, it is not essential that both an additional dark region and an additional light region are included in all final targets, and it is sufficient that at least two final targets included in a presentation video are obtained by adding an additional dark region to target objects having mutually different luminances, and at least two final targets included in the presentation video are obtained by adding an additional light region to target objects having mutually different luminances. For example, in a case where a final target A, a final target B, and a final target C are included in a presentation video, and the luminances of a target object B included in the final target B and a target object C included in the final target C are different from the luminance of a target object A included in the final target A, for example, the final target A may be obtained by adding an additional dark region A and an additional light region A to the target object A, the final target B may be obtained by adding an additional dark region B to the target object B, and the final target C may be obtained by adding an additional light region C to the target object C. With this form as a modification of the third embodiment, differences from the third embodiment will be described for the target object setting unit 110 and the final target setting unit 120 of the illusion video generation device 100 that include the differences from the third embodiment. The background setting unit 130 of the illusion video generation device 100 according to the modification of the third embodiment is the same as the background setting unit 130 of the illusion video generation device 100 according to the third embodiment. Furthermore, the illusion video presentation device 300 according to the modification of the third embodiment is the same as the illusion video presentation device 300 according to the third embodiment.

### Target Object Setting Unit 110

The target object setting unit 110 obtains a target object image that is an image including a first set of a plurality of target objects including target objects having mutually different luminances and a second set of a plurality of target objects including target objects having mutually different luminances (step S113A). An additional dark region is added to the first set of target objects by the final target setting unit 120 to be described below, and an additional light region is added to the second set of target objects by the final target setting unit 120 to be described below. There may be a target object included in both the first set and the second set, or there may be no target object included in both the first set and the second set. In a case where all target objects are included in both the first set and the second set, a target object image obtained by the target object setting unit 110 is similar to that of the third embodiment. Furthermore, in a case where there is no target object included in both the first set and the second set, the first set of target objects included in a target object image obtained by the target object setting unit 110 is similar to that of the first embodiment, and the second set of target objects included in the target object image obtained by the target object setting unit 110 is similar to that of the second embodiment.

The luminance conditions of the first set of target objects are the same as those in the first embodiment, and are as follows. The luminance of each target object is uniform. That is, in each target object, pixel values of all pixels included in the target object are substantially the same. The first set of a plurality of target objects includes at least target objects having mutually different luminances. That is, the luminances of all target objects of the first set may be different, but the luminances of all target objects of the first set cannot be the same. The luminances of all target objects of the first set are luminances between a predetermined maximum luminance and a predetermined minimum luminance, and are higher than the luminance of an additional dark region to be described below. That is, the luminances of all target objects of the first set are luminances between the luminance of an additional dark region and the predetermined maximum luminance, and more specifically, the luminances of all target objects of the first set are higher than the luminance of an additional dark region and lower than the predetermined maximum luminance.

The luminance conditions of the second set of target objects are the same as those in the second embodiment, and are as follows. The luminance of each target object is uniform. That is, in each target object, pixel values of all pixels included in the target object are substantially the same. The second set of a plurality of target objects includes at least target objects having mutually different luminances. That is, the luminances of all target objects of the second set may be different, but the luminances of all target objects of the second set cannot be the same. The luminances of all target objects of the second set are luminances between a predetermined maximum luminance and a predetermined minimum luminance, and are lower than the luminance of an additional light region to be described below. That is, the luminances of all target objects of the second set are luminances between the luminance of an additional light region and the predetermined minimum luminance, and more specifically, the luminances of all target objects of the second set are lower than the luminance of an additional light region and higher than the predetermined minimum luminance.

### Final Target Setting Unit 120

For the first set, the final target setting unit 120 adds an additional dark region to each target object similarly to the final target setting unit 120 of the first embodiment, and for the second set, adds an additional light region to each target object similarly to the final target setting unit 120 of the second embodiment, and for the first set and the second set, generates a target object to which at least one of an additional dark region or an additional light region is added as a final target, and obtains a final target image that is an image including a plurality of generated final targets (step S123A).

The luminance conditions of an additional dark region are as follows. The luminance of each additional dark region is uniform. The luminances of all additional dark regions are the same. The luminances of all additional dark regions are lower than the luminances of all target objects of the first set and higher than a predetermined minimum luminance (that is, minimum value of a luminance in a periodic temporal change of the luminance of the background region). That is, the pixel values of all pixels included in all additional dark regions are substantially the same value lower than the luminances of all target objects of the first set and higher than the predetermined minimum luminance.

The luminance conditions of an additional light region are as follows. The luminance of each additional light region is uniform. The luminances of all additional light regions are the same. The luminances of all additional light regions are higher than the luminances of all target objects of the second set and lower than a predetermined maximum luminance (that is, maximum value of a luminance in a periodic temporal change of the luminance of the background region). That is, the pixel values of all pixels included in all additional light regions are substantially the same value higher than the luminances of all target objects of the second set and lower than the predetermined maximum luminance.

### Fourth Embodiment

In a fourth embodiment, an illusion presentation system will be described that causes an illusion that a plurality of objects is moving at different timings by arranging a real object obtained by adding, to each of a plurality of target objects, at least one of a region having a luminance lower than that of the target object or a region having a luminance higher than that of the target object on a background that blinks in which the entire luminance is uniform.

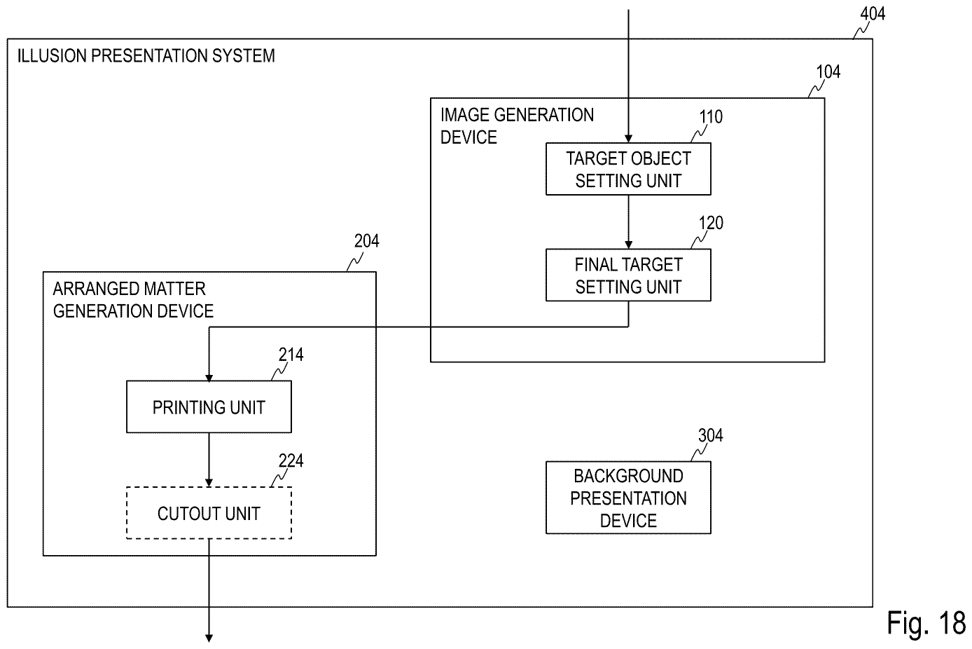

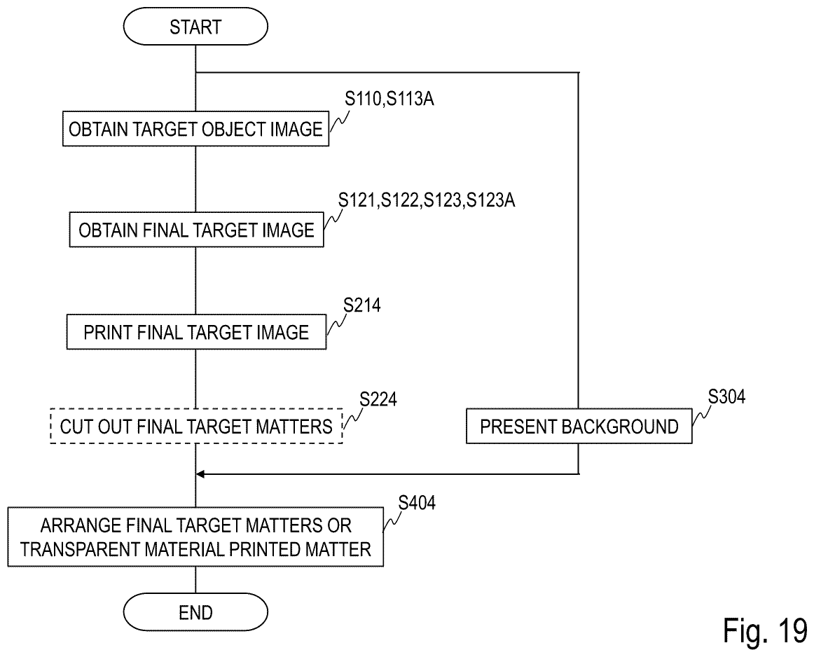

As illustrated in FIG. 18, an illusion presentation system 404 according to the fourth embodiment includes an image generation device 104, an arranged matter generation device 204, and a background presentation device 304. Hereinafter, the operation of the illusion presentation system 404 will be described focusing on differences from each of the above-described embodiments and modification also with reference to FIG. 19.

### Image Generation Device 104

The image generation device 104 includes a target object setting unit 110 and a final target setting unit 120. The target object setting unit 110 and the final target setting unit 120 of the image generation device 104 perform the same operation as any of the above-described embodiments and modification. That is, the target object setting unit 110 obtains target object images by the same operation as the target object setting unit 110 of any of the above-described embodiments and modification (step S110, S113A), and the final target setting unit 120 obtains a final target image by the same operation as that of the final target setting unit 120 of the same embodiment or modification as that in which the target object setting unit 110 has operated (step S121, S122, S123, S123A). The final target image obtained by the final target setting unit 120 is output from the image generation device 104 and input to the arranged matter generation device 204.

### Arranged Matter Generation Device 204

The arranged matter generation device 204 includes a printing unit 214 and a cutout unit 224.

### Printing Unit 214

A Final target image output from the image generation device 104 is input to the printing unit 214. The printing unit 214 obtains and outputs a printed matter obtained by printing the final target image on a flat material (step S214). Examples of the flat material include paper, wood, cloth, a glass plate, a synthetic resin plate, and a metal plate.

### Cutout Unit 224

A printed matter output by the printing unit 214 is input to the cutout unit 224. The cutout unit 224 cuts out regions where the final targets are printed from the printed matter and obtains and outputs the results as final target matters (step S224). The final target matters obtained by the cutout unit 224 are output from the arranged matter generation device 204. Since the printed matter includes a plurality of final targets, the arranged matter generation device 204 outputs a plurality of final target matters.

Note that, in a case where the printing unit 214 obtains a printed matter in which a final target image is printed on a transparent or translucent material (hereinafter, referred to as “transparent material printed matter”), the arranged matter generation device 204 may not include the cutout unit 224, and may not perform step S224 described above. That is, the arranged matter generation device 204 only needs to include the printing unit 214, and the printing unit 214 may perform step S214 described above to obtain a transparent material printed matter.

### Background Presentation Device 304

The background presentation device 304 includes a presentation surface 3041 that presents a background video. The background presentation device 304 presents, on the presentation surface 3041, a background video having a luminance that is uniform at each time and periodically and temporally changes between a predetermined maximum luminance and a predetermined minimum luminance lower than the maximum luminance (step S304).

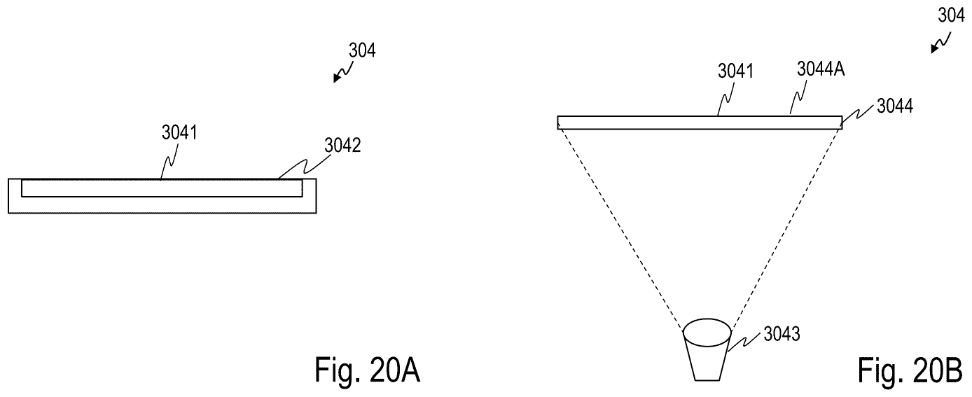

The background presentation device 304 includes a display screen such as a liquid crystal display device or an organic EL display device, and presents an input video on the display screen. In this example, as illustrated in FIG. 20A, a display screen 3042 of the background presentation device 304 is used as the presentation surface 3041. The background presentation device 304 displays, on the display screen 3042 (that is, presentation surface 3041), a background video having a luminance that is uniform at each time and periodically and temporally changes between a predetermined maximum luminance and a predetermined minimum luminance lower than the maximum luminance.

For example, as illustrated in FIG. 20B, the background presentation device 304 is a device including a light source 3043 and a translucent plate 3044 irradiated with light emitted from the light source 3043. In this example, a surface 3044A of the translucent plate 3044 opposite to the light source 3043 serves as the presentation surface 3041. The background presentation device 304 controls light emitted from the light source 3043 to the translucent plate 3044 such that the luminance of the surface 3044A (that is, presentation surface 3041) changes periodically and temporally between a predetermined maximum luminance and a predetermined minimum luminance lower than the maximum luminance. As a result, the background presentation device 304 presents, on the surface 3044A (that is, presentation surface 3041), a background video having a luminance that is uniform at each time and periodically and temporally changes between a predetermined maximum luminance and a predetermined minimum luminance lower than the maximum luminance.

In a case where a plurality of final target matters is arranged on the presentation surface 3041, the size of the presentation surface 3041 needs to be large enough so that a plurality of arranged matters is arranged in the range of a background video and visually recognized by an observer, and in a case where a transparent material printed matter is arranged on the presentation surface 3041, the size of the presentation surface 3041 needs to be large enough so that a plurality of arranged matters printed on a transparent material printed matter is arranged in the range of a background video and visually recognized by an observer.

### Illusion Presentation Method by Illusion Presentation System 404

In the illusion presentation system 404 according to the fourth embodiment, the final target matters or the transparent material printed matter output by the arranged matter generation device 204 is arranged on the presentation surface 3041 of the background presentation device 304 (step S404).

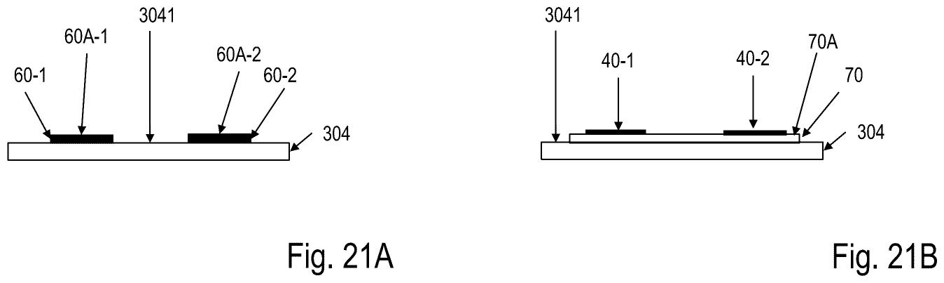

FIG. 21A is a diagram of an example in which a first final target matter 60-1 corresponding to a first final target 40-1 among a plurality of final target matters output by the arranged matter generation device 204 and a second final target matter 60-2 corresponding to a second final target 40-2 among the plurality of final target matters output by the arranged matter generation device 204 are arranged on the presentation surface 3041 of the background presentation device 304 as viewed from a cross section orthogonal to the presentation surface 3041. The first final target matter 60-1 is arranged on the presentation surface 3041 such that a surface opposite to a surface 60A-1 on which the first final target 40-1 is printed is on the presentation surface 3041 side. Similarly, the second final target matter 60-2 is arranged on the presentation surface 3041 such that a surface opposite to a surface 60A-2 on which the second final target 40-2 is printed is on the presentation surface 3041 side. In a case where arrangement is performed in this way, the luminances of the first final target matter 60-1 and the second final target matter 60-2 are visually recognized in a region where the first final target matter 60-1 is arranged and a region where the second final target matter 60-2 is arranged, respectively, in a region visually recognized by an observer, and the presentation surface 3041 of the background presentation device 304 is visually recognized in a region where neither the first final target matter 60-1 nor the second final target matter 60-2 is arranged.

FIG. 21B is a diagram of an example in which a transparent material printed matter 70 output by the arranged matter generation device 204 is arranged on the presentation surface 3041 of the background presentation device 304 as viewed from a cross section orthogonal to the presentation surface 3041. The first final target 40-1 and the second final target 40-2 are printed on a surface 70A of the transparent material printed matter 70. In a case where arrangement is performed in this way, the luminances of the first final target 40-1 and the second final target 40-2 are visually recognized in regions where the first final target 40-1 and the second final target 40-2 are arranged in the transparent material printed matter 70, respectively, in a region visually recognized by an observer, and the luminance of the presentation surface 3041 of the background presentation device 304 is visually recognized in a region where neither the first final target 40-1 nor the second final target 40-2 is arranged.

That is, according to the illusion presentation system 404 according to the fourth embodiment, similarly to a presentation video presented by the illusion video presentation device 300 according to each of the above-described embodiments and modification, an observer visually recognizes a state in which two or more final targets are arranged on a background having a luminance that periodically and temporally changes. Therefore, the observer has an illusion that visual objects based on the respective final targets are visually moving, similarly to each of the above-described embodiments and modification.

### Conclusion

According to the above-described embodiments and modification, the illusion video generation device of the present invention generates a video for causing an illusion that visual objects based on N (N is an integer of 2 or more) final targets are visually moving, and generates a video including the N final targets and a background region, and the N final targets and the background region satisfy the following conditions.
A first final target among the N final targets includes a first target object and a first additional region added to at least a part of a contour line of the first target object.
A second final target among the N final targets includes a second target object and a second additional region added to at least a part of a contour line of the second target object.
The luminance of the background region is uniform at each time, and periodically and temporally changes between a predetermined maximum luminance and a predetermined minimum luminance.
Each of the luminance of the first target object, the luminance of the second target object, the luminance of the first additional region, and the luminance of the second additional region is a uniform predetermined luminance that is between the maximum luminance and the minimum luminance and does not temporally change.
The luminance of the first target object and the luminance of the second target object are different.
The luminance of the first additional dark region and the luminance of the second additional dark region are same, and lower than the luminance of the first target object and the luminance of the second target object or higher than the luminance of the first target object and the luminance of the second target object.

Furthermore, according to the above-described embodiments and modification, the illusion video presentation device of the present invention presents a video for causing an illusion that visual objects based on N (N is an integer of 2 or more) final targets are visually moving, and presents a video including the N final targets and a background region, and the N final targets and the background region satisfy the following conditions.
A first final target among the N final targets includes a first target object and a first additional region added to at least a part of a contour line of the first target object.
A second final target among the N final targets includes a second target object and a second additional region added to at least a part of a contour line of the second target object.
The luminance of the background region is uniform at each time, and periodically and temporally changes between a predetermined maximum luminance and a predetermined minimum luminance.
Each of the luminance of the first target object, the luminance of the second target object, the luminance of the first additional region, and the luminance of the second additional region is a uniform predetermined luminance that is between the maximum luminance and the minimum luminance and does not temporally change.
The luminance of the first target object and the luminance of the second target object are different.
The luminance of the first additional dark region and the luminance of the second additional dark region are same, and lower than the luminance of the first target object and the luminance of the second target object or higher than the luminance of the first target object and the luminance of the second target object.

Furthermore, according to the above-described embodiments and modification, the illusion presentation system of the present invention causes an illusion that visual objects based on N (N is an integer of 2 or more) final targets are visually moving, in which N final target matters in which the respective final targets are visually recognized from the surface side or an arranged matter in which the N final targets are visually recognized from the surface side of a transparent or translucent material is arranged on a presentation surface, and the N final targets and the presentation surface satisfy the following conditions.
As a first final target among the N final targets, a first target object and a first additional region added to at least a part of a contour line of the first target object are visually recognized from the surface side.
As a second final target among the N final targets, a second target object and a second additional region added to at least a part of a contour line of the second target object are visually recognized from the surface side.
The luminance of the presentation surface is uniform at each time, and periodically and temporally changes between a predetermined maximum luminance and a predetermined minimum luminance.
Each of the luminance of the first target object, the luminance of the second target object, the luminance of the first additional region, and the luminance of the second additional region is a uniform predetermined luminance that is between the maximum luminance and the minimum luminance and does not temporally change.
The luminance of the first target object and the luminance of the second target object are different.
The luminance of the first additional region and the luminance of the second additional region are same, and lower than the luminance of the first target object and the luminance of the second target object or higher than the luminance of the first target object and the luminance of the second target object.

### Supplementary Note

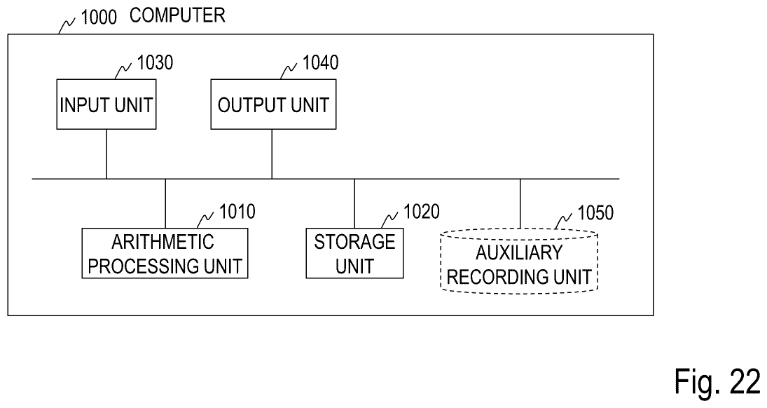

Each unit of the illusion video generation device and processing of the illusion video presentation device described above may be implemented by a computer, and, in this case, processing content of a function that each device should include is written by a program. By causing a storage unit 1020 of a computer 1000 illustrated in FIG. 22 to read this program and causing an arithmetic processing unit 1010, an input unit 1030, an output unit 1040, and the like to execute the program, various processing functions in each of the foregoing devices are implemented on the computer.

The device according to the present invention includes, for example, as a single hardware entity, an input unit to which a signal can be input from the outside of the hardware entity, an output unit that can output a signal to the outside of the hardware entity, a communication unit that can be connected to a communication device (e.g., a communication cable) capable of communicating with the outside of the hardware entity, a central processing unit (CPU which may include a cache memory or a register), a RAM or a ROM which is a memory, an external storage device as a hard disk, and a bus that connects the input unit, the output unit, the communication unit, the CPU, the RAM, the ROM, and the external storage device so that data can be exchanged therebetween. A device (drive) or the like that can write and read data in and from a recording medium such as a CD-ROM may be provided in the hardware entity as necessary. Examples of a physical entity including such a hardware resource include a general-purpose computer.

The external storage device of the hardware entity stores programs required for implementing the above-described functions, data required for processing of the programs, and the like (the programs may be stored, for example, in a ROM as a read-only storage device instead of the external storage device). Data or the like obtained by the processing of these programs is appropriately stored in a RAM, an external storage device, or the like.

In the hardware entity, each program stored in the external storage device (or ROM or the like) and data required for processing of each program are read into a memory as necessary and are appropriately interpreted and processed by the CPU. As a result, the CPU implements predetermined functions (each of the constituent units represented as. unit). That is, each of the constituent units of the embodiments of the present invention may include processing circuitry.

As described above, in a case where the processing function of the hardware entity (the device according to the present invention) described in the foregoing embodiments is implemented by a computer, processing details of the function of the hardware entity are described by a program. The computer then executes the program, and thus, the processing function of the hardware entity is implemented in the computer.

The program in which the processing content is written can be recorded on a computer-readable recording medium. The computer-readable recording medium is, for example, a non-transitory recording medium and is specifically a magnetic recording device, an optical disc, or the like.

In addition, distribution of the program is performed by, for example, selling, transferring, or renting a portable recording medium such as a DVD or a CD-ROM on which the program is recorded. Further, a configuration may also be employed in which the program is stored in a storage device in a server computer and the program is distributed by transferring the program from the server computer to other computers via a network.

For example, the computer that executes such a program first temporarily stores the program recorded in a portable recording medium or the program transferred from a server computer in an auxiliary recording unit 1050 that is a non-transitory storage device thereof. Then, at the time of performing processing, the computer reads the program stored in the auxiliary recording unit 1050 serving as the non-transitory storage device of the computer into the storage unit 1020 and performs processing according to the read program. As another embodiment of the program, the computer may directly read the program from the portable recording medium into the storage unit 1020 and perform processing according to the program, or, each time the program is transferred from the server computer to the computer, the computer may sequentially perform processing according to the received program. In addition, the above-described processing may be executed by a so-called application service provider (ASP) type service that implements a processing function only by an execution instruction and result acquisition without transferring the program from the server computer to the computer. Note that the program in this mode includes information that is to be used in processing by an electronic computer and is equivalent to the program (data and the like that are not direct commands to the computer but have properties that define the processing to be performed by the computer).

Further, in the present embodiment, the present device is configured by executing a predetermined program on the computer. On the other hand, at least part of the processing content may be implemented by hardware.

The present invention is not limited to the above-described embodiments and can be appropriately modified without departing from the gist of the present invention.

1. An illusion presentation system for causing an illusion that a visual object based on a first final target among N (N is an integer of 2 or more) final targets and a visual object based on a second final target among the N final targets are visually moving at different timings, wherein,
in the illusion presentation system, N final target matters in which the respective final targets are visually recognized from a surface side or an arranged matter in which the N final targets are visually recognized from a surface side of a transparent or translucent material is arranged on a presentation surface,
as a first final target among the N final targets, a first target object and a first additional region added to at least a part of a contour line of the first target object are visually recognized from a surface side,
as a second final target among the N final targets, a second target object and a second additional region added to at least a part of a contour line of the second target object are visually recognized from a surface side,
a luminance of the presentation surface is uniform at each time, and periodically and temporally changes between a maximum luminance that is predetermined and a minimum luminance that is predetermined,
a luminance of the first target object is a uniform predetermined luminance that is between the maximum luminance and the minimum luminance and does not temporally change,
a luminance of the second target object is a uniform predetermined luminance that is between the maximum luminance and the minimum luminance and does not temporally change,
a luminance of the first additional region is a uniform predetermined luminance that is between the maximum luminance and the minimum luminance and does not temporally change,
a luminance of the second additional region is a uniform predetermined luminance that is between the maximum luminance and the minimum luminance and does not temporally change,
a luminance of the first target object and a luminance of the second target object are different, and
a luminance of the first additional region and a luminance of the second additional region are same, and are lower than a luminance of the first target object and a luminance of the second target object or higher than a luminance of the first target object and a luminance of the second target object.

2. An illusion video presentation device comprises processing circuitry configured to present a video for causing an illusion that a visual object based on a first final target among N (N is an integer of 2 or more) final targets and a visual object based on a second final target among the N final targets are visually moving at different timings, wherein
a video presented by the illusion video presentation device includes the N final targets and a background region,
a first final target among the N final targets includes a first target object and a first additional region added to at least a part of a contour line of the first target object,
a second final target among the N final targets includes a second target object and a second additional region added to at least a part of a contour line of the second target object,
a luminance of the background region is uniform at each time, and periodically and temporally changes between a maximum luminance that is predetermined and a minimum luminance that is predetermined,
a luminance of the first target object is a uniform predetermined luminance that is between the maximum luminance and the minimum luminance and does not temporally change,
a luminance of the second target object is a uniform predetermined luminance that is between the maximum luminance and the minimum luminance and does not temporally change,
a luminance of the first additional region is a uniform predetermined luminance that is between the maximum luminance and the minimum luminance and does not temporally change,
a luminance of the second additional region is a uniform predetermined luminance that is between the maximum luminance and the minimum luminance and does not temporally change,
a luminance of the first target object and a luminance of the second target object are different, and
a luminance of the first additional region and a luminance of the second additional region are same, and are lower than a luminance of the first target object and a luminance of the second target object or higher than a luminance of the first target object and a luminance of the second target object.

3. An illusion video generation device comprises processing circuitry configured to generate a video for causing an illusion that a visual object based on a first final target among N (N is an integer of 2 or more) final targets and a visual object based on a second final target among the N final targets are visually moving at different timings, wherein
the illusion video generation device generates a video including the N final targets and a background region,
a first final target among the N final targets includes a first target object and a first additional region added to at least a part of a contour line of the first target object,
a second final target among the N final targets includes a second target object and a second additional region added to at least a part of a contour line of the second target object,
a luminance of the background region is uniform at each time, and periodically and temporally changes between a maximum luminance that is predetermined and a minimum luminance that is predetermined,
a luminance of the first target object is a uniform predetermined luminance that is between the maximum luminance and the minimum luminance and does not temporally change,
a luminance of the second target object is a uniform predetermined luminance that is between the maximum luminance and the minimum luminance and does not temporally change,
a luminance of the first additional region is a uniform predetermined luminance that is between the maximum luminance and the minimum luminance and does not temporally change,
a luminance of the second additional region is a uniform predetermined luminance that is between the maximum luminance and the minimum luminance and does not temporally change,
a luminance of the first target object and a luminance of the second target object are different, and
a luminance of the first additional dark region and a luminance of the second additional dark region are same, and are lower than a luminance of the first target object and a luminance of the second target object or higher than a luminance of the first target object and a luminance of the second target object.

4. An illusion video presentation method for presenting a video for causing an illusion that a visual object based on a first final target among N (N is an integer of 2 or more) final targets and a visual object based on a second final target among the N final targets are visually moving at different timings, wherein
a video presented by the illusion video presentation method includes the N final targets and a background region,
a first final target among the N final targets includes a first target object and a first additional region added to at least a part of a contour line of the first target object,
a second final target among the N final targets includes a second target object and a second additional region added to at least a part of a contour line of the second target object,
a luminance of the background region is uniform at each time, and periodically and temporally changes between a maximum luminance that is predetermined and a minimum luminance that is predetermined,
a luminance of the first target object is a uniform predetermined luminance that is between the maximum luminance and the minimum luminance and does not temporally change,
a luminance of the second target object is a uniform predetermined luminance that is between the maximum luminance and the minimum luminance and does not temporally change,
a luminance of the first additional region is a uniform predetermined luminance that is between the maximum luminance and the minimum luminance and does not temporally change,
a luminance of the second additional region is a uniform predetermined luminance that is between the maximum luminance and the minimum luminance and does not temporally change,
a luminance of the first target object and a luminance of the second target object are different, and
a luminance of the first additional region and a luminance of the second additional region are same, and are lower than a luminance of the first target object and a luminance of the second target object or higher than a luminance of the first target object and a luminance of the second target object.

5. An illusion video generation method for generating a video for causing an illusion that a visual object based on a first final target among N (N is an integer of 2 or more) final targets and a visual object based on a second final target among the N final targets are visually moving at different timings, wherein
the illusion video generation method is for generating a video including the N final targets and a background region,
a first final target among the N final targets includes a first target object and a first additional region added to at least a part of a contour line of the first target object,
a second final target among the N final targets includes a second target object and a second additional region added to at least a part of a contour line of the second target object,
a luminance of the background region is uniform at each time, and periodically and temporally changes between a maximum luminance that is predetermined and a minimum luminance that is predetermined,
a luminance of the first target object is a uniform predetermined luminance that is between the maximum luminance and the minimum luminance and does not temporally change,
a luminance of the second target object is a uniform predetermined luminance that is between the maximum luminance and the minimum luminance and does not temporally change,
a luminance of the first additional region is a uniform predetermined luminance that is between the maximum luminance and the minimum luminance and does not temporally change,
a luminance of the second additional region is a uniform predetermined luminance that is between the maximum luminance and the minimum luminance and does not temporally change,
a luminance of the first target object and a luminance of the second target object are different, and
a luminance of the first additional dark region and a luminance of the second additional dark region are same, and are lower than a luminance of the first target object and a luminance of the second target object or higher than a luminance of the first target object and a luminance of the second target object.

6. A non-transitory computer-readable recording medium storing a program for causing a computer to function as the illusion video presentation device according to claim 2.

7. A non-transitory computer-readable recording medium storing a program for causing a computer to function as the illusion video generation device according to claim 3.
